(19) United States
(12) Patent Application Publication
(10) Pub. No.: US 2023/0238583 A1
(43) Pub. Date: Jul. 27, 2023

(54) SECONDARY BATTERY, AND VEHICLE INCLUDING SECONDARY BATTERY

(71) Applicant: SEMICONDUCTOR ENERGY LABORATORY CO., LTD., Atsugi-shi Kanagawa-ken (JP)

(72) Inventors: Kaori OGITA, Isehara, Kanagawa (JP); Kazutaka KURIKI, Ebina, Kanagawa (JP); Yumiko YONEDA, Isehara, Kanagawa (JP); Hiroshi KADOMA, Sagamihara, Kanagawa (JP); Kunihiko SUZUKI, Isehara, Kanagawa (JP); Yuji IWAKI, Isehara, Kanagawa (JP); Shunpei YAMAZAKI, Setagaya, Tokyo (JP)

(21) Appl. No.: 17/925,357

(22) PCT Filed: May 10, 2021
(86) PCT No.: PCT/IB2021/053934

§ 371 Date: Nov. 15, 2022

(30) Foreign Application Priority Data
May 22, 2020 (JP) 2020-090096

(51) Int. Cl. H01M 10/0569; H01M 4/583

(52) U.S. Cl. CPC H01M 10/0569; H01M 4/583; H01M 2004/028

(57) ABSTRACT

According to one embodiment of the present invention, a secondary battery that can be used at a wide range of temperatures and is less likely to be influenced by an environmental temperature is provided. Furthermore, a secondary battery with high safety is provided. An electrolyte obtained by mixing an acyclic ester having high temperature characteristics with a fluorinated carbonic ester at 5 vol. % or higher, preferably 20 vol. % or higher, is used for the purpose of reducing interface resistance between an electrode and an electrolyte, whereby a secondary battery capable of operating at a wide range of temperatures, specifically, at temperatures higher than or equal to −40° C. and lower than or equal to 150° C., preferably higher than or equal to −40° C. and lower than or equal to 85° C. can be achieved.

### TECHNICAL FIELD

One embodiment of the present invention relates to a secondary battery and a manufacturing method thereof. Furthermore, one embodiment of the present invention relates to a vehicle and the like including secondary batteries.

One embodiment of the present invention relates to an object, a method, or a manufacturing method. The present invention relates to a process, a machine, manufacture, or a composition of matter. One embodiment of the present invention relates to a semiconductor device, a display device, a light-emitting device, a power storage device, a lighting device, an electronic device, or a manufacturing method thereof.

Note that electronic devices in this specification mean all devices including power storage devices, and electro-optical devices including power storage devices, information terminal devices including power storage devices, and the like are all electronic devices.

Note that in this specification, a power storage device refers to every element and device having a function of storing power. For example, a power storage device (also referred to as a secondary battery) such as a lithium-ion secondary battery, a lithium-ion capacitor, and an electric double layer capacitor are included.

### BACKGROUND ART

In recent years, a variety of power storage devices such as lithium-ion secondary batteries, lithium-ion capacitors, and air batteries, which utilize an electrochemical reaction, have been actively developed. In particular, demand for lithium-ion secondary batteries with high output and high energy density has rapidly grown with the development of the semiconductor industry, for portable information terminals such as mobile phones, smartphones, and laptop personal computers, portable music players, digital cameras, medical equipment, next-generation clean energy vehicles such as hybrid electric vehicles (HVs), electric vehicles (EVs), and plug-in hybrid electric vehicles (PHVs), and the like, and the lithium-ion secondary batteries are essential as rechargeable energy supply sources for today's information society.

Lithium-ion secondary batteries have a problem in charging and discharging at low temperatures or high temperatures. Secondary batteries, which are power storage means utilizing chemical reaction, cannot easily show their full performance particularly at low temperatures below freezing. At high temperatures, the lifetime of a secondary battery might be shortened and an abnormality might occur in a lithium-ion secondary battery.

Desired secondary batteries are those capable of showing stable performance regardless of the environmental temperature at the time when used or preserved.

Patent Document 1 discloses a lithium-ion secondary battery using an organic compound containing fluorine is used.

### REFERENCE

### Patent Document

[Patent Document 1] U.S. patent Ser. No. 10/483,522

### SUMMARY OF THE INVENTION

### Problems to be Solved by the Invention

An object of one embodiment of the present invention is to provide a secondary battery that can be used at a wide range of temperatures and is less likely to be influenced by an environmental temperature. Another object is to provide a secondary battery with high safety.

Another object of one embodiment of the present invention is to provide a novel material, an electrolyte, a power storage device, or a manufacturing method thereof.

Note that the description of these objects does not preclude the existence of other objects. One embodiment of the present invention does not have to achieve all these objects. Other objects can be derived from the description of the specification, the drawings, and the claims.

### Means for Solving the Problems

An electrolyte obtained by mixing an acyclic ester having high temperature characteristics with a fluorinated carbonic ester of 5 vol. % or higher, preferably 20 vol. % or higher, is used for the purpose of reducing interface resistance between an electrode and an electrolyte, whereby a secondary battery capable of operating at a wide range of temperatures, specifically, at temperatures higher than or equal to −40° C. and lower than or equal to 150° C., preferably higher than or equal to −40° C. and lower than or equal to 85° C. can be achieved.

A structure disclosed in this specification is a secondary battery including a positive electrode, an electrolyte, and a negative electrode, in which the electrolyte contains an acyclic ester and a fluorinated carbonic ester of 5 vol. % or higher and 95 vol. % or lower, preferably 5 vol. % or higher and 50 vol. % or lower, further preferably 5 vol. % or higher and 30 vol. % or lower.

Lithium ions are dissolved in an electrolyte while the lithium ions are coordinated to and solvated by a solvent having high dielectric constant. With a difference in potential or concentration as propulsion, the lithium ions coordinated to the solvent are diffused. When the lithium ions enter a layer of a positive electrode or a negative electrode, the lithium ions approach the surface of the positive electrode or the negative electrode while the solvent is removed. Lithium ions in the state of being coordinated to solvent molecules, i.e., in a solvated state, are more stable than lithium ions alone. Therefore, energy is needed in a desolvation process of removing solvent molecules, thereby causing interface resistance in conducting lithium ions.

Use at both high temperature range and low temperature range with the above-described electrolyte becomes possible by the following principle: an F atom that is an electron-withdrawing group is substituted in a desolvation process of removing solvent molecules to reduce the electron density of a carboxy group, whereby desolvation is easily caused and the interface resistance is reduced. Fluorine of the fluorinated carbonic ester has an effect of reducing solvation energy.

A positive electrode active material or a negative electrode active material might be changed in volume owing to charge and discharge; however, an organic compound containing fluorine, such as an fluorinated carbonic ester, positioned between active materials maintains smoothness and inhibits a crack even when the volume change occurs at the time of charge and discharge, so that an effect of improving cycle characteristics is obtained. It is important that the organic compound containing fluorine exists between a plurality of positive electrode active materials. Furthermore, it is important that the organic compound containing fluorine exists between a plurality of negative electrode active materials.

As components of the electrolyte, one kind or two or more kinds of fluorinated cyclic carbonate are preferably used in combination. Fluorinated cyclic carbonate can improve incombustibility and enhance safety of a lithium ion secondary battery. As the fluorinated cyclic carbonate, fluorinated ethylene carbonate, e.g., monofluoroethylene carbonate (carbonic fluoroethylene, FEC, F1EC), difluoroethylene carbonate (DFEC, F2EC), trifluoroethylene carbonate (F3EC), or tetrafluoroethylene carbonate (F4EC), can be used, for example. Note that DFEC has isomers such as cis-4,5 or trans-4,5. Lithium ions are solvated with the use of one kind or two or more kinds of fluorinated cyclic carbonate as the components of the electrolyte to make the lithium ions transferred between the positive electrode and the negative electrode at the time of charge and discharge; this is important for operation at low temperatures. When the fluorinated cyclic carbonate is not used as a small amount of addition agent but contributes to transfer of lithium ions in charge and discharge, operation at low temperatures is possible.

Monofluoroethylene carbonate (FEC) is represented by the following formula (1), for example.

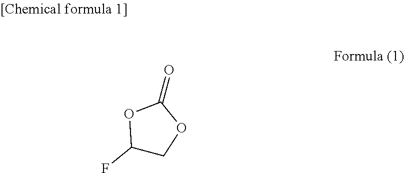

Tetrafluoroethylene carbonate (F4EC) is represented by the following formula (2).

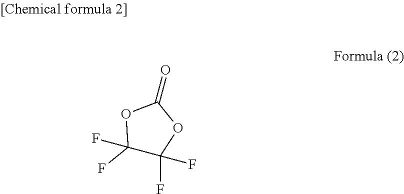

Difluoroethylene carbonate (DFEC) is represented by the following formula (3).

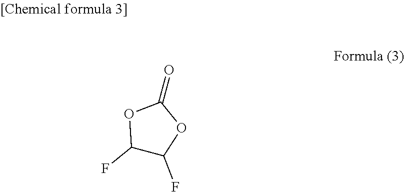

It is known that fluorinated cyclic carbonate is used as an addition agent of an electrolyte at less than 5 vol. % in the whole electrolyte of a secondary battery. One of features of one embodiment of the present invention is using fluorinated cyclic carbonate as not an addition agent but a component of the electrolyte. The use of fluorinated cyclic carbonate as a component of the electrolyte reduces desolvation energy required when lithium ions solvated in the electrolyte enter the positive electrode (or the negative electrode). When the desolvation energy can be made small, lithium ions can be easily intercalated or deintercalated to/from the positive electrode (or the negative electrode) even in a low temperature range. In addition, the electrolyte is not limited to fluorinated cyclic carbonate as long as the electrolyte has an effect of reducing solvation energy. For example, cyclic carbonate having a cyano group can also be used. A cyano group and a fluoro group are also called electron-withdrawing groups.

Another structure disclosed in this specification is a secondary battery including a positive electrode, an electrolyte, and a negative electrode, in which the electrolyte contains an acyclic ester and cyclic carbonate with an electron-withdrawing group of 5 vol. % or higher and 95 vol. % or lower, preferably 5 vol. % or higher and 50 vol. % or lower, further preferably 5 vol. % or higher and 30 vol. % or lower.

In the above structure, the electron-withdrawing group is a fluoro group or a cyano group.

In the above structure, ethylene carbonate-based compound represented by the following formula (4) can be used as the electrolyte, and R1 and R2 are the same as or different from each other and selected from a group consisting of hydrogen, a fluoro group, a cyano group, and a fluorinated alkyl group having 1 to 5 carbon atoms; note that both R1 and R2 are not hydrogen. At least one of R1 and R2 is preferably an electron-withdrawing group.

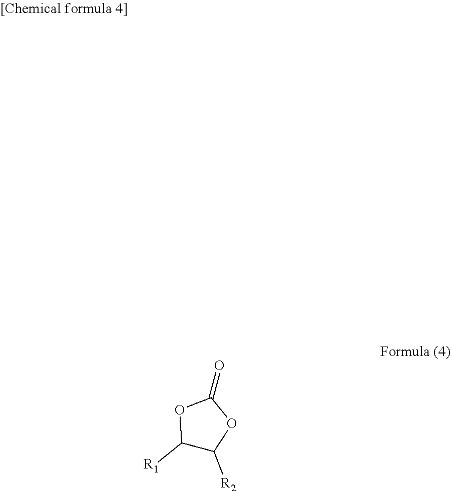

In each of the above structures, the acyclic ester is contained at 5 vol. % or higher and 80 vol. % or lower. Furthermore, the acyclic ester may contain fluorine.

In this specification, a component of an electrolyte means one that is contained at 5 vol. % or higher in the whole electrolyte of a secondary battery. Here, “5 vol. % or higher in the whole electrolyte of a secondary battery” refers to a ratio of the component to the electrolyte, which is weighed at the time of manufacturing the secondary battery. In the case where the secondary battery is disassembled after manufactured, while it is difficult to quantitate the ratio of a plurality of kinds of electrolytes, it is possible to determine whether or not a certain kind of organic substance is contained at 5 vol. % or higher in the whole electrolyte.

As the acyclic ester with high temperature characteristics, dimethyl carbonate (DMC), ethyl methyl carbonate (EMC), diethyl carbonate (DEC), or the like is used.

For example, dimethyl carbonate (DMC) is represented by the following formula (5).

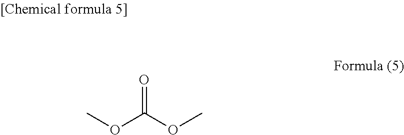

Furthermore, ethyl methyl carbonate (EMC) is represented by the following formula (6).

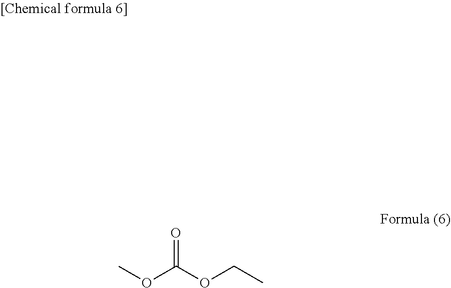

Moreover, diethyl carbonate (DEC) is represented by the following formula (7).

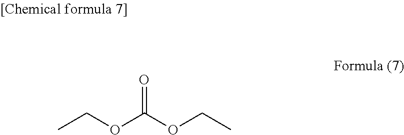

In this specification, an electrolyte is a generic term for materials including a solid material, a liquid material, and a semisolid material.

In any of the above structures, the positive electrode includes graphene or carbon nanotube.

In any of the above structures, the positive electrode includes a positive electrode active material, and the magnesium concentration of a surface portion of the positive electrode active material is higher than the magnesium concentration of the inside of the positive electrode active material.

In any of the above structures, the positive electrode includes a positive electrode active material, and the positive electrode active material contains fluorine.

### Effect of the Invention

One embodiment of the present invention enables use of a secondary battery at a wide range of temperatures, specifically, at temperatures higher than or equal to −40° C. and lower than or equal to 150° C. Accordingly, even when the temperature outside a vehicle provided with the secondary battery of one embodiment of the present invention is higher than or equal to −40° C. and lower than 25° C., or higher than or equal to 25° C. and lower than or equal to 85° C., it is possible to drive the vehicle with the secondary battery used as a power source

### BRIEF DESCRIPTION OF THE DRAWINGS

FIG. 1 is a schematic cross-sectional view illustrating the state of lithium ions inside a secondary battery before charge.

FIG. 2 is a schematic cross-sectional view illustrating the state of lithium ions inside a secondary battery immediately after the start of charge.

FIG. 3 is a schematic cross-sectional view illustrating the state of lithium ions inside a secondary battery during charge.

FIG. 4 is a schematic cross-sectional view illustrating a diffusion state of lithium ions inside a secondary battery during charge.

FIG. 5 is a schematic cross-sectional view illustrating the state of lithium ions inside a secondary battery at the time when charge is terminated.

FIG. 6 is a schematic cross-sectional view illustrating the state of lithium ions inside a secondary battery immediately after the start of discharge.

FIG. 7 is a schematic cross-sectional view illustrating the state of lithium ions inside a secondary battery during discharge.

FIG. 8 is a schematic cross-sectional view illustrating a diffusion state of lithium ions inside a secondary battery during discharge.

FIG. 9 is a schematic cross-sectional view illustrating the state of lithium ions inside a secondary battery at the time when discharge is terminated.

FIG. 10 is a schematic cross-sectional view illustrating the internal state of a secondary battery.

FIG. 11A illustrates a comparative example, and FIG. 11B and FIG. 11C illustrate chemical formulae representing one embodiment of the present invention, and calculated electric charge of an oxygen atom coordinated to a lithium ion.

FIG. 12 is a graph showing solvation energy calculated in the state where one to four organic compounds are coordinated to a lithium ion representing one embodiment of the present invention.

FIG. 13 is a graph showing analysis of electric charge of an oxygen atom coordinated to a lithium ion representing one embodiment of the present invention and solvation energy.

FIG. 14A and FIG. 14B are diagrams showing a method for manufacturing a material.

FIG. 15A, FIG. 15B, FIG. 15C, and FIG. 15D are cross-sectional views illustrating examples of a positive electrode of a secondary battery.

FIG. 16A is a perspective view of a coin-type secondary battery, and FIG. 16B is a cross-sectional perspective view thereof.

FIG. 17A and FIG. 17B illustrate examples of a cylindrical secondary battery, FIG. 17C illustrates an example of a plurality of cylindrical secondary batteries, and FIG. 17D illustrates an example of a power storage system including a plurality of cylindrical secondary batteries.

FIG. 18A and FIG. 18B are diagrams illustrating examples of a secondary battery, and FIG. 18C is a diagram illustrating the internal state of a secondary battery.

FIG. 19A, FIG. 19B, and FIG. 19C are diagrams illustrating an example of a secondary battery.

FIG. 20A and FIG. 20B are external views of a secondary battery.

FIG. 21A, FIG. 21B, and FIG. 21C are diagrams illustrating a method for forming a secondary battery.

FIG. 22A is a perspective view of a battery pack of one embodiment of the present invention, FIG. 22B is a block diagram of a battery pack, and FIG. 22C is a block diagram of a vehicle having a motor.

FIG. 23A to FIG. 23D are diagrams illustrating examples of transport vehicles.

FIG. 24A and FIG. 24B are diagrams illustrating power storage devices of one embodiment of the present invention.

FIG. 25A to FIG. 25D are diagrams illustrating examples of electronic devices.

FIG. 26A is a graph showing results of 1C cycle tests at 85° C., and FIG. 26B is a graph showing results of 1C cycle tests at 60° C.

FIG. 27A is a graph showing results of 1C cycle tests at 0° C., and FIG. 27B is a graph showing results of 0.05C charge and discharge tests at −40° C.

FIG. 28A is a graph showing results of 1C cycle tests at 85° C., and FIG. 28B is a graph showing results of 1C cycle tests at 60° C.

FIG. 29A is a graph showing results of 1C cycle tests at 0° C., and FIG. 29B is a graph showing results of 0.05C charge and discharge tests at −40° C.

### MODE FOR CARRYING OUT THE INVENTION

Embodiments of the present invention are described in detail below with reference to the drawings. Note that the present invention is not limited to the following descriptions, and it is readily understood by those skilled in the art that modes and details of the present invention can be modified in various ways. In addition, the present invention should not be construed as being limited to the descriptions of the embodiments below.

### Embodiment 1

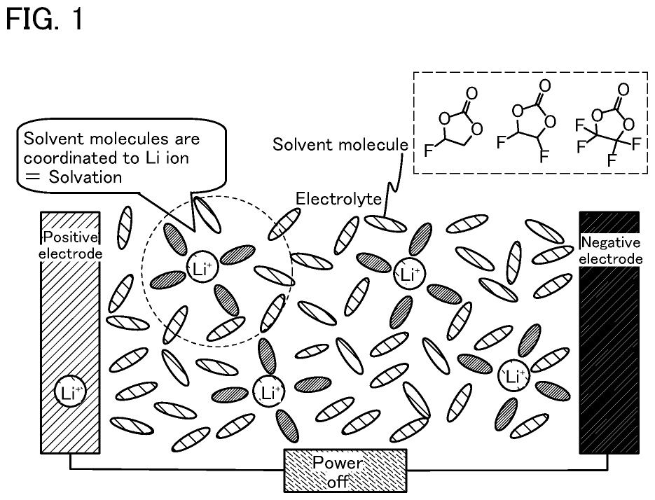

FIG. 1 to FIG. 9 are schematic views illustrating the state of lithium ions transported inside a secondary battery of one embodiment of the present invention. Note that anions in an electrolyte, such as a PF₆⁻ ion, are not illustrated for simplification. Furthermore, a separator provided between a positive electrode and a negative electrode is not illustrated. Note that a separator is unnecessary in some cases when the secondary battery is a semi-solid-state battery.

FIG. 1 is a schematic cross-sectional view illustrating the state of lithium ions inside the secondary battery before charge. (Step 1)

As illustrated in FIG. 1, an organic compound containing fluorine (also referred to as solvent molecules) is placed as an electrolyte between the positive electrode and the negative electrode. In FIG. 1, each of a plurality of ellipses is a solvent molecule and is monofluoroethylene carbonate (FEC), difluoroethylene carbonate (DFEC), or tetrafluoroethylene carbonate (F4EC). The solvent molecule is not limited to three materials of chemical formulae shown in FIG. 1, and an acyclic ester is also coordinated to a lithium ion to solvate the lithium ion in some cases. Also in the case where ethylene carbonate (EC) or propylene carbonate (PC) is used for the solvent molecules, ethylene carbonate (EC) or propylene carbonate (PC) is coordinated to a lithium ion to solvate the lithium ion in some cases. For the solvent molecules, an aprotic organic solvent is used; γ-butyrolactone, acetonitrile, dimethoxyethane, tetrahydrofuran, and the like are given in addition those described above, and one or more of them can be used. When a gelled high-molecular material is used for the electrolyte, safety against liquid leakage and the like is improved. Typical examples of gelled high-molecular materials include a silicone gel, an acrylic gel, an acrylonitrile gel, a polyethylene oxide-based gel, a polypropylene oxide-based gel, and a gel of a fluorine-based polymer. FIG. 1 shows a power-off state. Solvent molecules are coordinated to and solvate some lithium ions in FIG. 1. In practice, all the lithium ions in the electrolyte are solvated in FIG. 1. In the inside of the secondary battery before charge illustrated in FIG. 1, the number of lithium ions is determined by the concentration of a lithium salt added to the electrolyte.

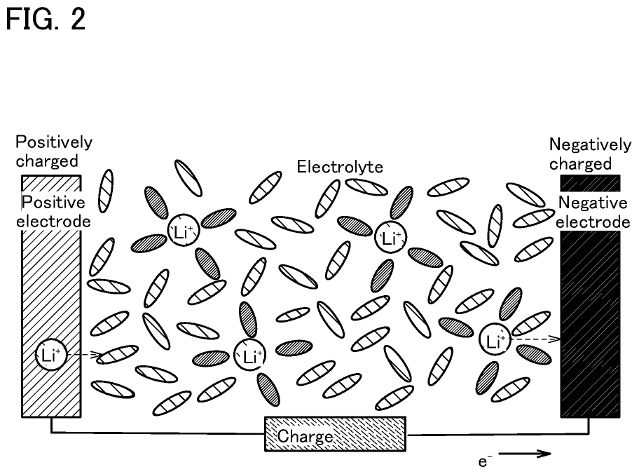

A state at the time when charge of the secondary battery is started is illustrated in FIG. 2. FIG. 2 is a schematic cross-sectional view illustrating the state of lithium ions inside the secondary battery immediately after the start of charge. (Step 2)

When charge is started, the positive electrode is positively charged, and lithium ions contained in the positive electrode start to be eluted into the electrolyte. Furthermore, the negative electrode is negatively charged, and lithium ions are taken in the negative electrode from the electrolyte near the negative electrode.

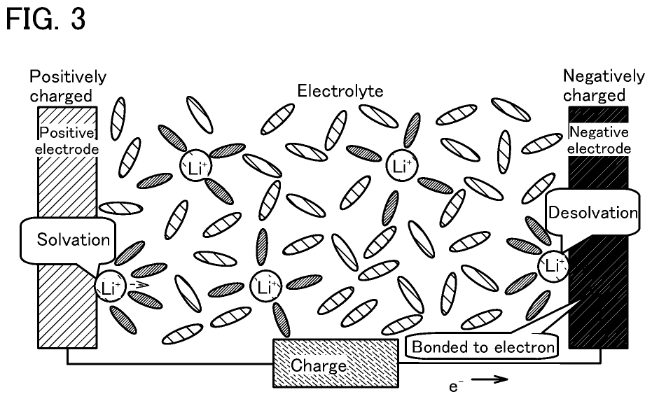

The state of the secondary battery during charge is illustrated in FIG. 3. FIG. 3 is a schematic cross-sectional view illustrating the state of lithium ions inside the secondary battery during charge. (Step 3)

The lithium ion that has been eluted into the electrolyte from the positive electrode is surrounded by and solvated by a plurality of solvent molecules. Furthermore, lithium ions near the negative electrode enter the negative electrode while being desolvated to be bonded to electrons. Since organic compounds containing fluorine (e.g., FEC) have lower solvation energy for a lithium ion than organic compounds with similar structures not including fluorine (e.g., EC), they are solvated or desolvated easily. In addition, as charge progresses, the lithium ion concentration of a region near the positive electrode becomes higher, whereas the lithium ion concentration of a region near the negative electrode becomes lower.

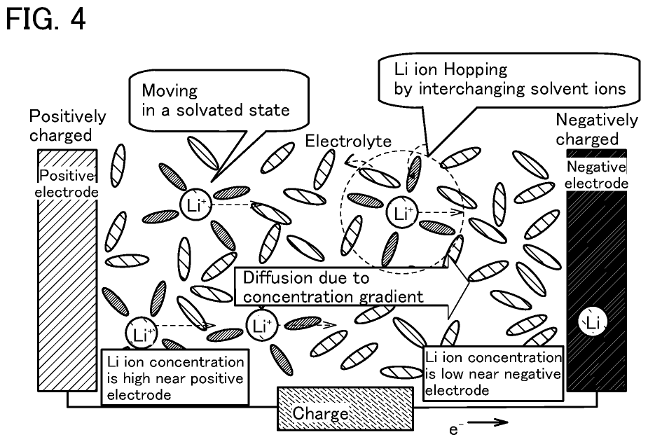

The state of the secondary battery during charge after a gradient of the lithium ion concentration is generated is illustrated in FIG. 4. FIG. 4 is a schematic cross-sectional view illustrating a diffusion state of lithium ions inside the secondary battery during charge. (Step 4)

To make the concentration uniform in the electrolyte, diffusion of lithium ions occurs. Lithium ions sometimes move remaining in a solvated state, and a hopping phenomenon in which coordinated solvent molecules are interchanged occurs in some cases.

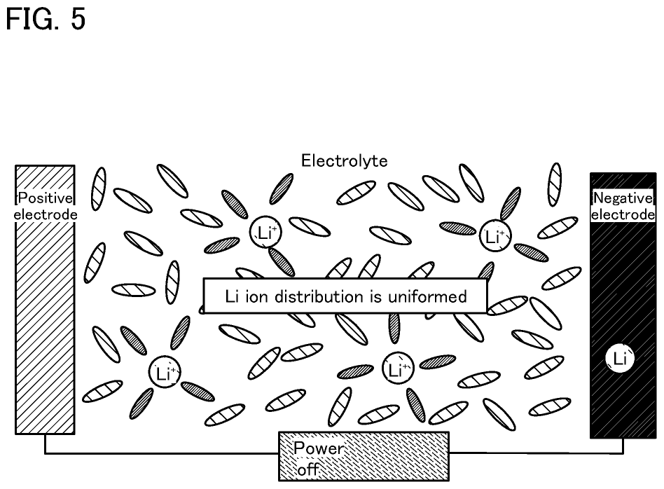

The internal state of the secondary battery at the time when a predetermined voltage is reached is illustrated in FIG. 5. FIG. 5 is a schematic cross-sectional view illustrating the state of lithium ions inside the secondary battery at the time when charge is terminated. (Step 5)

The secondary battery terminates charge when the predetermined voltage is reached. Although distribution of lithium ions in the electrolyte is not uniform immediately after the termination of charge, when a certain time has elapsed, the distribution of lithium ions becomes uniform as illustrated in FIG. 5; such a state can be referred to as a charge termination state.

Step 1 to Step 5 described above show the diffusion state of lithium ions from the start of charge until the termination of charge.

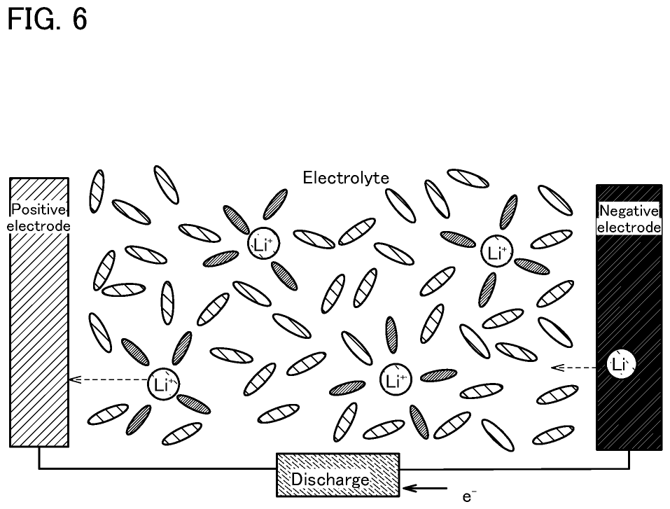

Next, FIG. 6 to FIG. 9 illustrate discharge.

A state at the time when discharge of the secondary battery is started is illustrated in FIG. 6. FIG. 6 is a schematic cross-sectional view illustrating the state of lithium ions inside the secondary battery immediately after the start of discharge. (Step 6)

When discharge is started, to make lithium ions and the positive electrode active material in a more stable state, lithium in the negative electrode is eluted into the electrolyte as lithium ions. Furthermore, the positive electrode active material takes in the lithium ions of the electrolyte near the positive electrode.

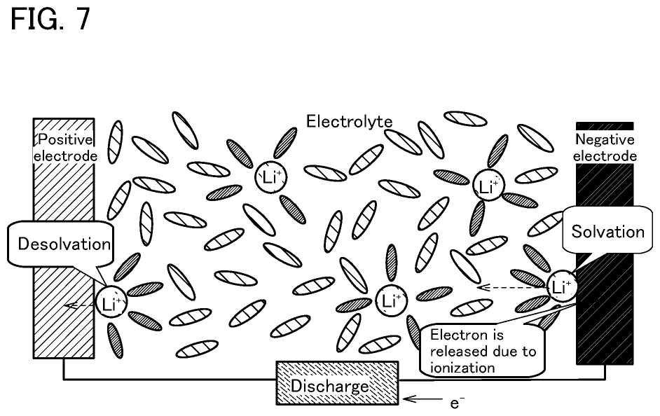

The state of the secondary battery during discharge is illustrated in FIG. 7. FIG. 7 is a schematic cross-sectional view illustrating the state of lithium ions inside the secondary battery during discharge. (Step 7)

Lithium in the negative electrode is eluted into the electrolyte as lithium ions while being solvated. At this time, electrons are released owing to ionization of lithium to become a discharge current. Lithium ions in a region near the positive electrode are taken in the positive electrode while being desolvated. In the positive electrode active material, electric charge is kept neutral mainly owing to a change in the valence of a transition metal. In this manner, lithium ions are eluted from the negative electrode and taken in the positive electrode, whereby a gradient of the lithium ion concentration is generated in the electrolyte.

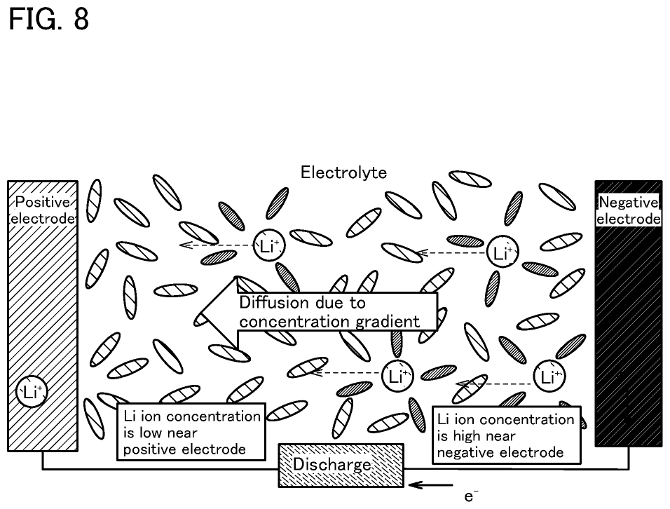

The state of the secondary battery during discharge after the gradient of the lithium ion concentration is generated is illustrated in FIG. 8. FIG. 8 is a schematic cross-sectional view illustrating a diffusion state of lithium ions inside the secondary battery during discharge. (Step 8)

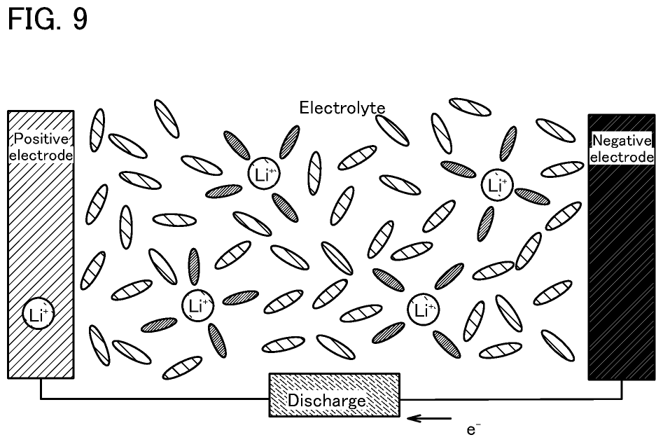

Lithium ions capable of moving to the positive electrode from the negative electrode are reduced, and lithium ions sequentially move to the positive electrode from the negative electrode; then, when there is no lithium in the negative electrode or when all the positions for lithium ions in the positive electrode are filled and more lithium ions cannot enter the positive electrode, discharge is terminated finally. Upon termination of discharge, no more discharge currents are generated, and lithium ions are diffused uniformly in the electrolyte; the resulting internal state of the secondary battery is illustrated in FIG. 9. FIG. 9 is a schematic cross-sectional view illustrating the state of lithium ions inside the secondary battery at the time when discharge is terminated. (Step 9)

Step 6 to Step 9 described above show the diffusion state of lithium ions from the start of discharge until the termination of discharge.

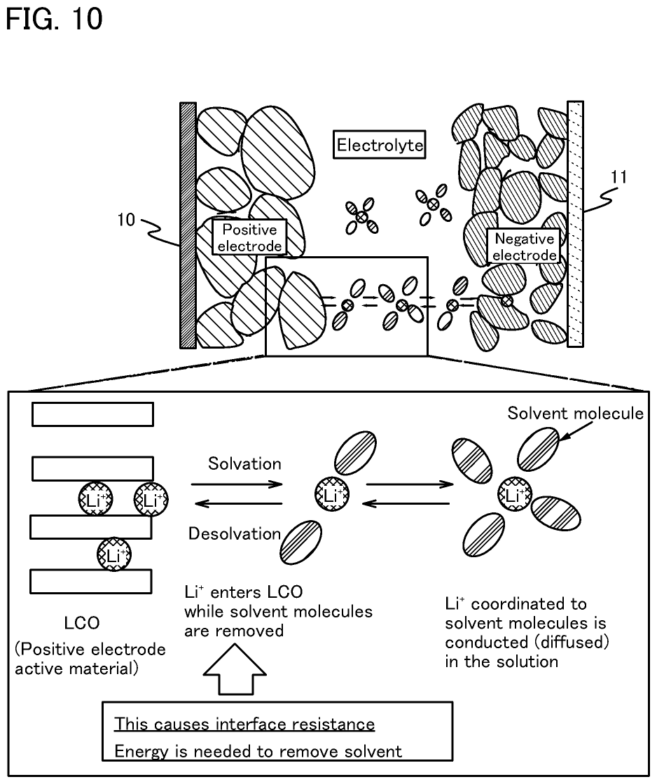

FIG. 10 is a schematic cross-sectional view illustrating the internal state of the secondary battery. Note that a separator for preventing a short-circuit between the positive electrode and the negative electrode is not illustrated in FIG. 10. The positive electrode includes at least a positive electrode current collector 10 and a positive electrode active material layer formed in contact with the positive electrode current collector 10, and the negative electrode includes at least a negative electrode current collector 11 and a negative electrode active material layer formed in contact with the negative electrode current collector 11.

FIG. 10 illustrates the state where four solvent molecules are coordinated to one lithium ion solvated in the electrolyte and two solvent molecules are coordinated to one lithium ion. FIG. 10 also illustrates an enlarged view of a region around the positive electrode at the time of charge and discharge of the secondary battery, showing the state of a lithium ion moving (or diffusing) between the positive electrode and the negative electrode. Specifically, a lithium ion moves to the negative electrode at the time of charge. Furthermore, the lithium ion moves to the positive electrode at the time of discharge.

A lithium ion released from the electrode at the time of charge and discharge is bonded to part of the electrolyte. Note that the bond is caused owing to a weak bond (coordination) with electrostatic force or the like. Such a bond state with the coordination may also be referred to as a solvate. When an organic compound that can solvate a lithium ion contains fluorine, a desolvation energy required when a lithium ion solvated in the electrolyte enters the positive electrode (or the negative electrode) becomes small.

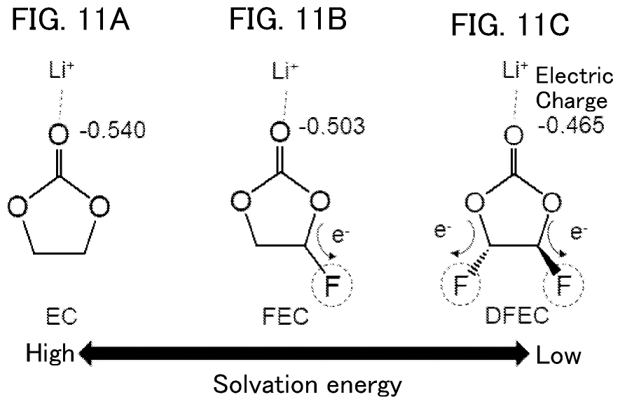

FIG. 11 illustrates lithium ions and three kinds of examples of organic compounds that can solvate the lithium ions. Note that ethylene carbonate (EC) illustrated in FIG. 11A is a comparative example, and chemical formulae of monofluoroethylene carbonate (fluoroethylene carbonate, FEC) illustrated in FIG. 11B and difluoroethylene carbonate (DFEC) illustrated in FIG. 11C and calculated electric charge of oxygen atoms coordinated to the lithium ions are illustrated. As illustrated in FIG. 11B and FIG. 11C, when the organic compound that can solvate the lithium ion contains fluorine, the fluorine withdraws an electron and thus the electron density of the oxygen atom coordinated to the lithium ion decreases, whereby the Coulomb force between the lithium ion and the organic compound becomes weaker than that of the comparative example (EC). For the calculation, Gaussian 09 was used as the quantum chemistry computational program. As a functional and a basis function, B3LYP and 6-311G (d,p) were used, respectively.

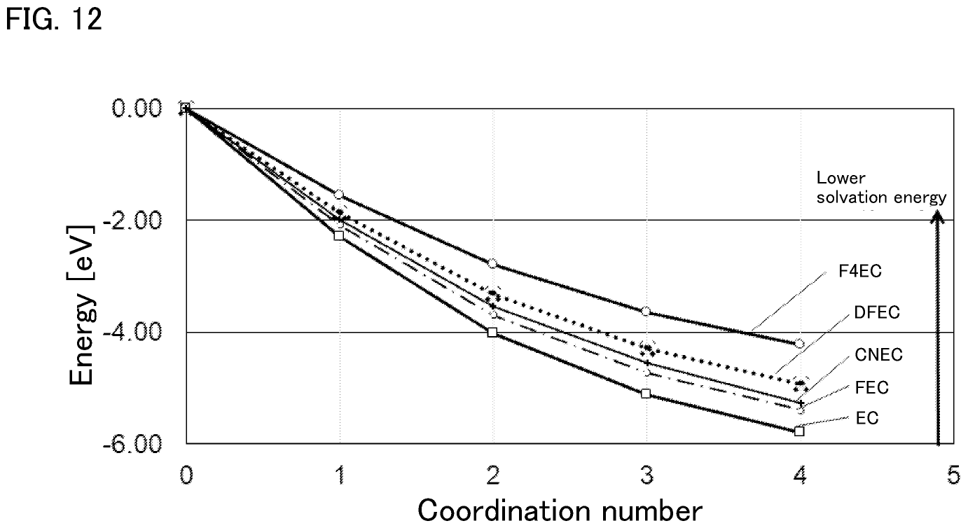

The solvation energy of tetrafluoroethylene carbonate (F4EC), which is a compound containing a larger amount of fluorine than difluoroethylene carbonate (DFEC), is calculated and shown in FIG. 12. FIG. 12 shows the results of calculation performed in the state where one to four organic compounds are coordinated to a lithium ion. FIG. 12 also shows the calculation result of the solvation energy of a cyclic carbonate having a cyano group (CNEC).

As shown in FIG. 12, each solvation energy is lower than that of the comparative example (EC), and the tetrafluoroethylene carbonate (F4EC) has the smallest solvation energy value.

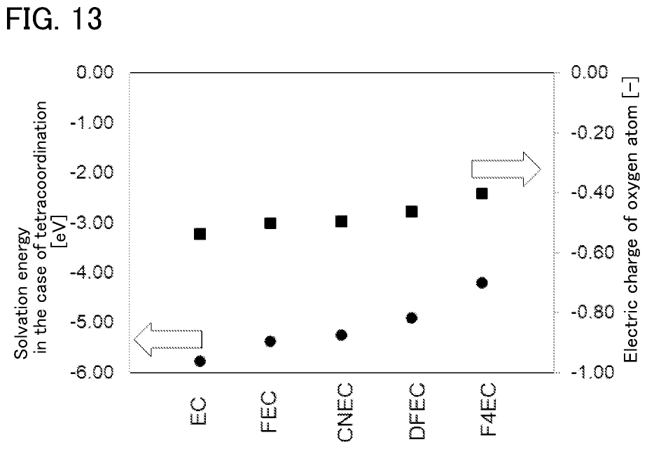

Moreover, in order to examine whether a difference in solvation energy affects the Coulomb force between the lithium ion and the electrolyte, the electric charge of the oxygen atom coordinated to the lithium ion was analyzed. FIG. 13 shows the analysis results.

It is found from the results in FIG. 13 that the smaller the amount of negative electric charge of the oxygen atom coordinated to the lithium ion is, the lower the level of stabilization of energy by solvation tends to be.

Introduction of a large number of cyano groups or fluoro groups, which are electron-withdrawing groups, into a molecule can reduce the interface resistance between the electrode and the electrolyte relating to desolvation.

Accordingly, with use of an organic compound having a cyano group or a fluoro group for an electrolyte, a secondary battery can be operated even at low temperatures (higher than or equal to −40° C. and lower than 25° C.) or high temperatures (higher than or equal to 25° C. and lower than or equal to 85° C.). An experiment has verified that charge and discharge are difficult at a low temperature (−40° C.) when an electrolyte in which EC of the comparative example and diethyl carbonate (DEC) are mixed is used for a secondary battery. Meanwhile, another experiment has verified that charge and discharge are possible at a low temperature (−40° C.) when an electrolyte in which monofluoroethylene carbonate (FEC) and diethyl carbonate (DEC) are mixed is used for a secondary battery. Although the mixing ratio of FEC to DEC can be adjusted appropriately by practitioners, at least the proportion of FEC in the whole electrolyte used for the secondary battery is set at 5 vol. % or higher, preferably 5 vol. % or higher and 50 vol. % or lower, further preferably 5 vol. % or higher and 30 vol. % or lower.

### Embodiment 2

In this embodiment, a positive electrode active material used in the secondary battery of one embodiment of the present invention is described.

Examples of a positive electrode active material include composite oxides having an olivine crystal structure, a layered rock-salt crystal structure, and a spinel crystal structure. Examples include compounds such as LiFePO₄, LiFeO₂, LiNiO₂, LiMn₂O₄, V₂O₅, Cr₂O₅, and MnO₂.

As a positive electrode active material, it is preferable to mix lithium nickel oxide (LiNiO₂ or LiNi₁₋ₓMₓO₂ (0<x<1) (M=Co, Al, or the like)) with a lithium-containing material that has a spinel crystal structure and contains manganese, such as LiMn₂O₄. This composition can improve the characteristics of the secondary battery.

As a positive electrode active material, a lithium-manganese composite oxide that can be represented by a composition formula LiₐMn_{b}M_{c}O_{d} can be used. Here, the element M is preferably silicon, phosphorus, or a metal element other than lithium and manganese, and further preferably nickel. When all the particles of a lithium-manganese composite oxide are measured, it is preferable to satisfy 0<a/(b+c)<2; c>0; and 0.26≤(b+c)/d<0.5 at the time of discharge. Note that the proportions of metals, silicon, phosphorus, and the like in all the particles of a lithium-manganese composite oxide can be measured with, for example, an ICP-MS (inductively coupled plasma-mass spectrometer). The proportion of oxygen in all the particles of a lithium-manganese composite oxide can be measured by, for example, EDX (energy dispersive X-ray spectroscopy). Moreover, the proportion of oxygen can be measured using fusion gas analysis and valence evaluation with XAFS (X-ray absorption fine structure) spectroscopy in combination with ICPMS analysis. Note that a lithium-manganese composite oxide is an oxide containing at least lithium and manganese, and may contain at least one element selected from a group consisting of chromium, cobalt, aluminum, nickel, iron, magnesium, molybdenum, zinc, indium, gallium, copper, titanium, niobium, silicon, phosphorus, and the like.

### <Example of Manufacturing Method of Cobalt-Containing Material>

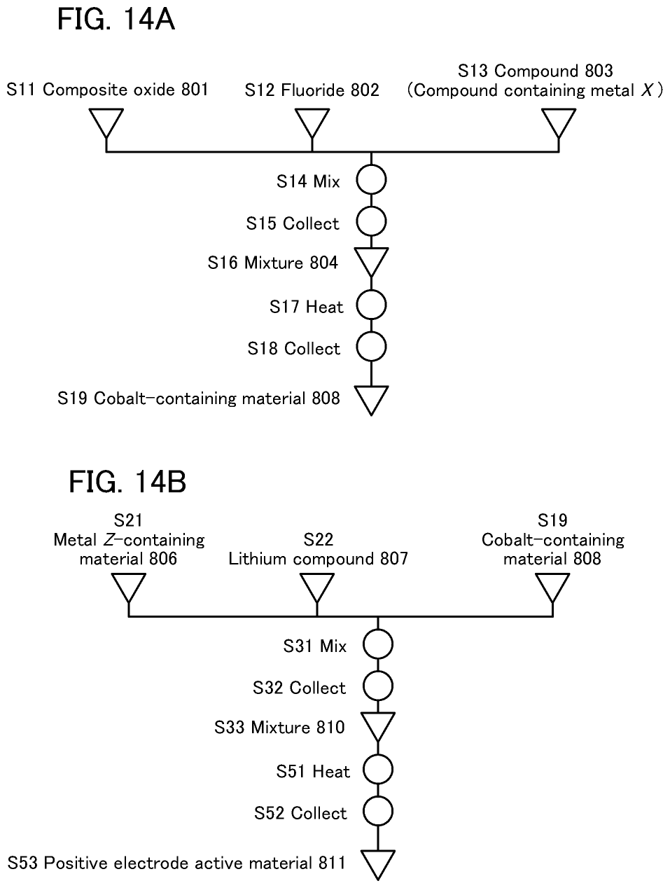

Next, an example of a manufacturing method of LiMO₂ of one embodiment of a material that can be used as the positive electrode active material is described with reference to FIG. 14A. The metal M contains a metal Me1. The metal Me1 may contain one or more kinds of metals (here, represented by a metal Me1-2) selected from nickel, manganese, aluminum, iron, vanadium, chromium, and niobium, in addition to cobalt. The metal M can contain another element (the metal X or a metal Z) in addition to the metal Me1 given above. The metal X or the metal Z is a metal other than cobalt, and for example, a metal such as magnesium, calcium, zirconium, lanthanum, barium, copper, potassium, sodium, or zinc can be used as the metal X or the metal Z. In particular, magnesium is preferably used as the metal X. In addition, there is no particular limitation on the substituent of the metal element. A substitution position of the metal M is not particularly limited. A cobalt-containing material in which the metal X is Mg is described as an example below. Note that the positive electrode active material of one embodiment of the present invention has a crystal structure of a lithium composite oxide represented by LiMO₂, but the composition is not limited to Li:M:O=1:1:2.

First, in Step S11, a composite oxide containing lithium, a transition metal, and oxygen is used as a composite oxide 801. Here, one or more transition metals including cobalt are preferably used.

The composite oxide containing lithium, a transition metal, and oxygen can be synthesized by heating a lithium source and a transition metal source in an oxygen atmosphere. As the transition metal source, a metal that can form, together with lithium, a layered rock-salt composite oxide belonging to the space group R-3m is preferably used. For example, at least one of manganese, cobalt, and nickel can be used. Aluminum may be used in addition to these transition metals. That is, as the transition metal source, only a cobalt source may be used; only a nickel source may be used; two types of cobalt and manganese sources or two types of cobalt and nickel sources may be used; or three types of cobalt, manganese, and nickel sources may be used. Furthermore, an aluminum source may be used in addition to these metal sources. The heating temperature at this time is preferably higher than a temperature in Step S17 described later. For example, the heating can be performed at 1000° C. This heating step is referred to as baking in some cases.

In the case where a composite oxide containing lithium, a transition metal, and oxygen that is synthesized in advance is used, a composite oxide with few impurities is preferably used. In this specification and the like, lithium, cobalt, nickel, manganese, aluminum, and oxygen are components contained in the composite oxide containing lithium, a transition metal, and oxygen, the cobalt-containing material, and the positive electrode active material, and elements other than the components are regarded as impurities. For example, when analyzed with a glow discharge mass spectroscopy method, the total impurity concentration is preferably less than or equal to 10,000 ppmw (parts per million weight), further preferably less than or equal to 5000 ppmw. In particular, the total impurity concentration of transition metals such as titanium and arsenic is preferably less than or equal to 3000 ppmw, further preferably less than or equal to 1500 ppmw.

For example, as lithium cobalt oxide synthesized in advance, lithium cobalt oxide particles (product name: CELLSEED C-10N) formed by NIPPON CHEMICAL INDUSTRIAL CO., LTD. can be used. This is lithium cobalt oxide in which the average particle diameter (D50) is approximately 12 μm, and in the impurity analysis by a glow discharge mass spectroscopy method (GD-MS), the magnesium concentration and the fluorine concentration are less than or equal to 50 ppmw, the calcium concentration, the aluminum concentration, and the silicon concentration are less than or equal to 100 ppmw, the nickel concentration is less than or equal to 150 ppmw, the sulfur concentration is less than or equal to 500 ppmw, the arsenic concentration is less than or equal to 1100 ppmw, and the concentrations of elements other than lithium, cobalt, and oxygen are less than or equal to 150 ppmw.

The composite oxide 801 in Step S11 preferably has a layered rock-salt crystal structure with few defects and distortions. Therefore, the composite oxide is preferably a composite oxide with few impurities. In the case where the composite oxide containing lithium, the transition metal, and oxygen includes a large number of impurities, the crystal structure is highly likely to have a large number of defects or distortions.

Furthermore, a fluoride 802 is prepared in Step S12. As the fluoride, for example, lithium fluoride (LiF), magnesium fluoride (MgF₂), aluminum fluoride (AlF₃), titanium fluoride (TiF₄), cobalt fluoride (CoF₂ and CoF₃), nickel fluoride (NiF₂), zirconium fluoride (ZrF₄), vanadium fluoride (VF₅), manganese fluoride, iron fluoride, chromium fluoride, niobium fluoride, zinc fluoride (ZnF₂), calcium fluoride (CaF₂), sodium fluoride (NaF), potassium fluoride (KF), barium fluoride (BaF₂), cerium fluoride (CeF₂), lanthanum fluoride (LaF₃), or sodium aluminum hexafluoride (Na₃AlF₆) can be used. As the fluoride 802, any material that functions as a fluorine source can be used. Thus, in place of the fluoride 802 or as part thereof, fluorine (F₂), carbon fluoride, sulfur fluoride, oxygen fluoride (OF₂, O₂F₂, O₃F₂, O₄F₂, or O₂F), or the like may be used and mixed in an atmosphere.

In the case where the fluoride 802 is a compound containing the metal X, a compound 803 (a compound containing the metal X) to be described later can also serve as the fluoride 802.

In this embodiment, lithium fluoride (LiF) is prepared as the fluoride 802. LiF is preferable because it has a cation common with LiCoO₂. LiF, which has a relatively low melting point of 848° C., is preferable because it is easily melted in an annealing process described later.

In the case where LiF is used as the fluoride 802, the compound 803 (the compound containing the metal X) is preferably prepared in addition to the fluoride 802 in Step S13. The compound 803 is the compound containing the metal X

In Step S13, the compound 803 is prepared. As the compound 803, a fluoride, an oxide, a hydroxide, or the like of the metal X can be used, and in particular, a fluoride is preferably used.

In the case where magnesium is used as the metal X, MgF₂ or the like can be used as the compound 803. Magnesium can be distributed at a high concentration in the vicinity of the surface of the cobalt-containing material.

In addition to the fluoride 802 and the compound 803, a material containing a metal that is neither cobalt nor the metal X may be mixed. As the material containing a metal that is neither cobalt nor the metal X, a nickel source, a manganese source, an aluminum source, an iron source, a vanadium source, a chromium source, a niobium source, a titanium source, or the like can be mixed, for example. For example, a hydroxide, a fluoride, an oxide, or the like of each metal is preferably pulverized and mixed. The pulverization can be performed by a wet method, for example.

The sequence of Step S11, Step S12, and Step S13 may be freely determined.

Next, in Step S14, the materials prepared in Step S11, Step S12, and Step S13 are mixed and ground. Although the mixing can be performed by a dry method or a wet method, a wet method is preferable because the materials can be ground to a smaller size. When the mixing is performed by a wet method, a solvent is prepared. As the solvent, ketone such as acetone, alcohol such as ethanol or isopropanol, ether, dioxane, acetonitrile, N-methyl-2-pyrrolidone (NMP), or the like can be used. An aprotic solvent that hardly reacts with lithium is further preferably used. In this embodiment, acetone is used.

For example, a ball mill, a bead mill, or the like can be used for the mixing. When a ball mill is used, zirconia balls are preferably used as media, for example. The mixing and grinding steps are preferably performed sufficiently to pulverize powder to be a mixture 804.

The materials mixed and ground in the above manner are collected in Step S15, whereby the mixture 804 is obtained in Step S16.

For example, the D50 of the mixture 804 is preferably greater than or equal to 600 nm and less than or equal to 20 μm, further preferably greater than or equal to 1 μm and less than or equal to 10 μm.

A temperature higher than or equal to the temperature at which the mixture 804 melts is preferable. The annealing temperature is preferably lower than or equal to a decomposition temperature of LiCoO₂ (1130° C.).

LiF is used as the fluoride 802 and the annealing in S17 is performed with a lid put on, whereby a cobalt-containing material 808 with favorable cycle performance and the like can be manufactured. The cobalt-containing material 808 contains the metal X. It is considered that when LiF and MgF₂ are used as the fluoride 802, the reaction with LiCoO₂ is promoted with the annealing temperature in S16 set to higher than or equal to 742° C. to generate LiMO₂ because the eutectic point of LiF and MgF₂ is around 742° C.

Furthermore, an endothermic peak of LiF, MgF₂, and LiCoO₂ is observed at around 820° C. by differential scanning calorimetry (DSC measurement). Thus, the annealing temperature is preferably higher than or equal to 742° C., further preferably higher than or equal to 820° C.

Accordingly, the annealing temperature is preferably higher than or equal to 742° C. and lower than or equal to 1130° C., further preferably higher than or equal to 742° C. and lower than or equal to 1000° C. Moreover, the annealing temperature is preferably higher than or equal to 820° C. and lower than or equal to 1130° C., further preferably higher than or equal to 820° C. and lower than or equal to 1000° C.

In this embodiment, LiF, which is a fluoride, is considered to function as flux. Accordingly, since the capacity of the heating furnace is larger than the capacity of the container and LiF is lighter than oxygen, it is expected that LiF is volatilized and the reduction of LiF in the mixture 804 inhibits generation of LiMO₂. Therefore, heating needs to be performed while volatilization of LiF is inhibited.

Thus, when the mixture 804 is heated in an atmosphere including LiF, that is, the mixture 804 is heated in a state where the partial pressure of LiF in the heating furnace is high, volatilization of LiF in the mixture 804 is inhibited. By performing annealing using the fluoride (LiF or MgF) to form an eutectic mixture with the lid put on, the annealing temperature can be lowered to the decomposition temperature of LiCoO₂ (1130° C.) or lower, specifically, a temperature higher than or equal to 742° C. and lower than or equal to 1000° C., thereby enabling the generation of LiMO₂ to progress efficiently. Accordingly, a cobalt-containing material having favorable characteristics can be formed, and the annealing time can be reduced.

An example of the annealing method in S17 is described below.

The heating furnace used for annealing includes a space in the heating furnace, a hot plate, a heater unit, and a heat insulator. It is further preferable to put a lid on a container in annealing. With this structure, an atmosphere including a fluoride can be obtained in a space enclosed by the container and the lid. In the annealing, the state of the space is maintained with the lid put on so that the concentration of the gasified fluoride inside the space can be constant or cannot be reduced, in which case fluorine or magnesium can be contained in the vicinity of the particle surface. The atmosphere including a fluoride can be provided in the space, which is smaller in capacity than the space in the heating furnace, by volatilization of a smaller amount of a fluoride. This means that an atmosphere including a fluoride can be provided in the reaction system without a significant reduction in the amount of a fluoride included in the mixture 804.

Accordingly, LiMO₂ can be produced efficiently. In addition, the use of the lid allows the annealing of the mixture 804 in an atmosphere including a fluoride to be simply and inexpensively performed.

Here, the valence number of Co (cobalt) in LiMO₂ formed according to one embodiment of the present invention is preferably approximately 3. The valence number of cobalt can be 2 or 3. Thus, to inhibit reduction of cobalt, it is preferable that the atmosphere in the space in the heating furnace include oxygen, further preferable that the ratio of oxygen to nitrogen in the atmosphere in the space in the heating furnace be higher than or equal to that in the air atmosphere, and still further preferable that the oxygen concentration in the atmosphere in the space in the heating furnace be higher than or equal to that in the air atmosphere. Thus, an atmosphere including oxygen needs to be introduced into the space in the heating furnace. Note that since bivalent cobalt atoms existing near magnesium atoms are likely to be stable, not all the cobalt atoms may be trivalent.

Thus, in one embodiment of the present invention, before heating is performed, a step of providing an atmosphere including oxygen in the space in the heating furnace and a step of placing the container in which the mixture 804 is placed in the space in the heating furnace are performed. The steps in this order enable the mixture 804 to be annealed in an atmosphere including oxygen and a fluoride. During the annealing, the space in the heating furnace is preferably sealed to prevent any gas from being discharged to the outside. For example, it is preferable that no gas flows during the annealing.

Although there is no particular limitation on the method of providing an atmosphere including oxygen in the space in the heating furnace, examples are a method of introducing an oxygen gas or a gas containing oxygen such as dry air after exhausting air from the space in the heating furnace and a method of flowing an oxygen gas or a gas containing oxygen such as dry air into the space in the heating furnace for a certain period of time. In particular, introducing an oxygen gas after exhausting air from the space in the heating furnace (oxygen displacement) is preferably performed. Note that the atmosphere of the space in the heating furnace may be regarded as an atmosphere including oxygen.

When the lid is put on the container, an atmosphere containing oxygen is provided, and then heating is performed, an appropriate amount of oxygen enters the container through a gap of the lid put on the container and an appropriate amount of fluoride can be kept within the container.

Furthermore, the fluoride or the like attached to inner walls of the container and the lid is likely to be fluttered again by the heating and attached to the mixture 804.

The annealing in Step S17 is preferably performed at an appropriate temperature for an appropriate time. The appropriate temperature and time change depending on the conditions such as the particle size and the composition of the particle of the composite oxide 801 in Step S11. In the case where the particle size is small, the annealing is preferably performed at a lower temperature or for a shorter time than the case where the particle size is large, in some cases. After the annealing in S17, a step of removing the lid is performed.

For example, in the case where the average particle diameter (D50) of particles in Step S11 is approximately 12 μm, the annealing time is preferably 3 hours or longer, further preferably 10 hours or longer.

By contrast, in the case where the average particle diameter (D50) of particles in Step S11 is approximately 5 μm, the annealing time is preferably longer than or equal to 1 hour and shorter than or equal to 10 hours, further preferably approximately 2 hours, for example.

The temperature decreasing time after the annealing is, for example, preferably longer than or equal to 10 hours and shorter than or equal to 50 hours.

Then, the materials annealed in the above manner are collected in Step S18, whereby the cobalt-containing material 808 is obtained in Step S19.

### [Structure of Positive Electrode Active Material]

A material with a layered rock-salt crystal structure, such as lithium cobalt oxide (LiCoO₂), is known to have a high discharge capacity and excel as a positive electrode active material of a secondary battery. As an example of the material with a layered rock-salt crystal structure, a composite oxide represented by LiMO₂ is given. The metal M contains the metal Me1 given above. The metal M can contain the metal X and the metal Z given above in addition to the metal Me1 given above. For example, as shown in the flow chart of FIG. 14B, a positive electrode active material 811 is formed using a metal Z-containing material 806, a lithium compound 807, and the cobalt-containing material 808. First, the metal Z-containing material 806 in Step S 21 is prepared. Furthermore, the lithium compound 807 in Step S22 is prepared. As shown in FIG. 14B, the metal Z-containing material 806, the lithium compound 807, and the cobalt-containing material 808 are mixed in Step S31. As the mixing method, for example, a solid-phase method, a sol-gel method, a sputtering method, or a CVD method can be used. For example, in the case where zirconium is used as the metal Z, a sol-gel method is used, and zirconium(IV) propoxide can be used. As the alcohol, for example, isopropanol can be used. In Step S32, the materials mixed in the above manner are collected, whereby the mixture 810 is obtained in Step S33. Next, in Step S51, the mixture 810 is heated. Then, in Step S52, the materials annealed in the above manner are collected, whereby the positive electrode active material 811 is obtained in Step S53. The positive electrode active material 811 contains at least cobalt, fluorine, the metal X, and the metal Z.

It is known that the Jahn-Teller effect in a transition metal compound varies in degree according to the number of electrons in the d orbital of the transition metal.

In a compound containing nickel, distortion is likely to be caused because of the Jahn-Teller effect in some cases. Accordingly, when charge and discharge with high voltage are performed on LiNiO₂, the crystal structure might be broken because of the distortion. The influence of the Jahn-Teller effect is suggested to be small in LiCoO₂; hence, LiCoO₂ is preferable because the resistance to high-voltage charge and discharge is higher in some cases.

In the positive electrode active material formed by the above manufacturing method, the difference in the positions of CoO₂ layers can be small in repeated charge and discharge at high voltage. Furthermore, the change in the volume can be small. Thus, the compound can have excellent cycle performance. In addition, the compound can have a stable crystal structure in a high-voltage charged state. Thus, in the compound, sometimes a short circuit is less likely to occur while the high-voltage charged state is maintained. This is preferable because the safety is further improved.

The compound has a small change in the crystal structure and a small difference in volume per the same number of transition metal atoms between a sufficiently discharged state and a high-voltage charged state.

The positive electrode active material 811 contains lithium, the metal M, and oxygen. The positive electrode active material 811 contains the metal Me1 given above for the metal M. The metal M preferably includes the metal X given above in addition to the metal Me1 given above. Furthermore, halogen such as fluorine or chlorine is preferably contained.

The positive electrode active material 811 preferably has a form of particles. The magnesium concentration in the surface portion is higher than the magnesium concentration in the inner portion. The surface portion of the positive electrode active material 811 is located less than or equal to 10 nm, less than or equal to 5 nm, or less than or equal to 3 nm from the surface toward the inner portion, and may include a first region where the magnesium concentration is particularly high.

For example, the concentrations of elements such as the metal M each have a gradient in each of the regions such as the surface portion, the inner portion, and the first region of the surface portion. That is, for example, the concentration of each element does not change sharply but changes with a gradient in the boundary between the regions. Here, cobalt can be used as the metal M, and aluminum, nickel, or the like can be used as the metal X in addition to magnesium, for example. In such a case, aluminum and nickel each have, for example, a concentration gradient in each of the regions such as the surface portion, the inner portion, and the first region of the surface portion.

The positive electrode active material 811 includes the first region. In the case where the positive electrode active material 811 has a form of particles, the first region preferably includes a region located inward from the surface portion. At least part of the surface portion may be included in the first region. The first region is preferably represented by a layered rock-salt crystal structure. The first region is a region containing lithium, the metal Me1, oxygen, and the metal X

In the first region, a change in the crystal structure when charge is performed at high voltage and a large amount of lithium is extracted is inhibited as compared with a comparative example described later.

More specifically, the structure of the first region is highly stable even when a charge voltage is high. Note that in the case where graphite, for instance, is used as a negative electrode active material in a secondary battery, a charge voltage region where the crystal structure can be maintained exists when the voltage of the secondary battery is, for example, higher than or equal to 4.3 V and lower than or equal to 4.5 V; in a higher charge voltage region, for example, at a voltage higher than or equal to 4.35 V and lower than or equal to 4.55 V with reference to the potential of a lithium metal, there is a region within which a stable crystal structure can be obtained.

Thus, in the first region, the crystal structure is less likely to be broken even when charge and discharge are repeated at high voltage.

The space group of a crystal structure is identified by XRD, electron diffraction, neutron diffraction, or the like. Thus, in this specification and the like, belonging to a space group or being a space group can be rephrased as being identified as a space group.

The positive electrode active material 811 with a charge depth in a sufficiently charged state includes a crystal whose structure is different from the H1-3 type crystal structure. This structure belongs to the space group R-3m and is a structure in which an ion of cobalt, magnesium, or the like occupies a site coordinated to six oxygen atoms. Furthermore, the symmetry of CoO₂ layers of this structure is the same as that in the O3 type structure. This structure is thus referred to as the O3′ type crystal structure in this specification and the like. In both the 03 type crystal structure and the O3′ type crystal structure, a slight amount of magnesium preferably exists between the CoO₂ layers, i.e., in lithium sites. In addition, a slight amount of fluorine preferably exists at random in oxygen sites.

Note that in the O3′ type crystal structure, a light element such as lithium sometimes occupies a site coordinated to four oxygen atoms.

In the unit cell of the O3′ type (pseudo-spinel) crystal structure, the coordinates of cobalt and oxygen can be represented by Co (0, 0, 0.5) and O (0, 0, x) within the range of 0.20≤x≤0.25.

A slight amount of magnesium existing between the CoO₂ layers, i.e., in lithium sites at random, has an effect of inhibiting a deviation in the CoO₂ layers in high-voltage charging. Thus, when magnesium exists between the CoO₂ layers, a stable crystal structure is likely to be formed. Therefore, magnesium is preferably distributed over whole particles of the positive electrode active material 811. In addition, to distribute magnesium over the whole particles, heat treatment is preferably performed in a formation process of the positive electrode active material 811.

However, cation mixing occurs when the heat treatment temperature is excessively high, so that magnesium is highly likely to enter the cobalt sites. Magnesium in the cobalt sites does not have the effect of maintaining the crystal structure at the time of charge with high voltage. Furthermore, heat treatment at an excessively high temperature might have an adverse effect; for example, cobalt might be reduced to have a valence of two or lithium might be evaporated.

In view of the above, a halogen compound such as a fluorine compound is preferably added to lithium cobalt oxide before the heat treatment for distributing magnesium over whole particles. The addition of the halogen compound depresses the melting point of lithium cobalt oxide. The decreased melting point makes it easier to distribute magnesium throughout the particle at a temperature at which the cation mixing is unlikely to occur.

When the magnesium concentration is higher than or equal to a desired value, the effect of stabilizing a crystal structure becomes small in some cases. This is probably because magnesium enters the cobalt sites in addition to the lithium sites. The number of magnesium atoms in the positive electrode active material formed by the above manufacturing method is preferably greater than or equal to 0.001 times and less than or equal to 0.1 times, further preferably greater than 0.01 times and less than 0.04 times, still further preferably approximately 0.02 times as large as the number of transition metal (cobalt) atoms. Alternatively, the number of magnesium atoms in the positive electrode active material formed by the above manufacturing method is preferably greater than or equal to 0.001 times and less than 0.04, or greater than or equal to 0.01 times and less than or equal to 0.1 times as large as the number of transition metal (cobalt) atoms. The magnesium concentration described here may be a value obtained by element analysis on the whole particles of the positive electrode active material using ICP-MS or the like, or may be a value based on the ratio of the raw materials mixed in the process of forming the positive electrode active material, for example.

The number of nickel atoms in the positive electrode active material 811 is preferably greater than 0% and less than or equal to 7.5%, further preferably greater than or equal to 0.05% and less than or equal to 4%, still further preferably greater than or equal to 0.1% and less than or equal to 2%, yet still further preferably greater than or equal to 0.2% and less than or equal to 1% of the number of cobalt atoms. Alternatively, the number of nickel atoms is preferably greater than 0% and less than or equal to 4% of the number of cobalt atoms. Alternatively, the number of nickel atoms is preferably greater than 0% and less than or equal to 2% of the number of cobalt atoms. Alternatively, the number of nickel atoms is preferably greater than or equal to 0.05% and less than or equal to 7.5% of the number of cobalt atoms. Alternatively, the number of nickel atoms is preferably greater than or equal to 0.05% and less than or equal to 2% of the number of cobalt atoms. Alternatively, the number of nickel atoms is preferably greater than or equal to 0.1% and less than or equal to 7.5% of the number of cobalt atoms. Alternatively, the number of nickel atoms is preferably greater than or equal to 0.1% and less than or equal to 4% of the number of cobalt atoms. The nickel concentration described here may be a value obtained by element analysis on all the particles of the positive electrode active material using GD-MS, ICP-MS, or the like, or may be a value based on the ratio of the raw materials mixed in the forming process of the positive electrode active material, for example.

The positive electrode active material 811 contains at least fluorine, in addition to cobalt, the metal M, the metal X, and oxygen. A combination with an electrolyte using a compound containing fluorine can produce a synergistic effect of improving the stability.

### <Particle Diameter>

A too large particle size of the positive electrode active material 811 causes problems such as difficulty in lithium diffusion and too much surface roughness of an active material layer in coating to a current collector. By contrast, too small a particle diameter causes problems such as difficulty in loading of the active material layer at the time when the material is applied to the current collector and overreaction with the electrolyte. Therefore, an average particle diameter (D50, also referred to as median diameter) is preferably greater than or equal to 1 μm and less than or equal to 100 μm, further preferably greater than or equal to 2 μm and less than or equal to 40 μm, still further preferably greater than or equal to 5 μm and less than or equal to 30 μm.

### <Analysis Method>

Whether or not a positive electrode active material has the O3′ type crystal structure when charged with high voltage can be determined by analyzing a high-voltage charged positive electrode using XRD, electron diffraction, neutron diffraction, electron spin resonance (ESR), nuclear magnetic resonance (NMR), or the like. The XRD is particularly preferable because the symmetry of a transition metal such as cobalt contained in the positive electrode active material can be analyzed with high resolution, the degrees of crystallinity and the crystal orientations can be compared, the distortion of lattice periodicity and the crystallite size can be analyzed, and a positive electrode obtained by disassembling a secondary battery can be measured without any change with sufficient accuracy, for example.

As described so far, the positive electrode active material 811 has a feature of a small change in the crystal structure between the high-voltage charged state and the discharged state. A material where 50 wt % or more of the crystal structure largely changes between the high-voltage charged state and the discharged state is not preferable because the material cannot withstand the high-voltage charge and discharge. In addition, it should be noted that an objective crystal structure is not obtained in some cases only by addition of impurity elements. Thus, the crystal structure of the positive electrode active material 811 is preferably analyzed by XRD or the like. The combination of the analysis methods and measurement such as XRD enables more detailed analysis.

Note that a positive electrode active material in the high-voltage charged state or the discharged state sometimes causes a change in the crystal structure when exposed to air. Thus, all samples are preferably handled in an inert atmosphere such as an atmosphere including argon.

### [Positive Electrode]

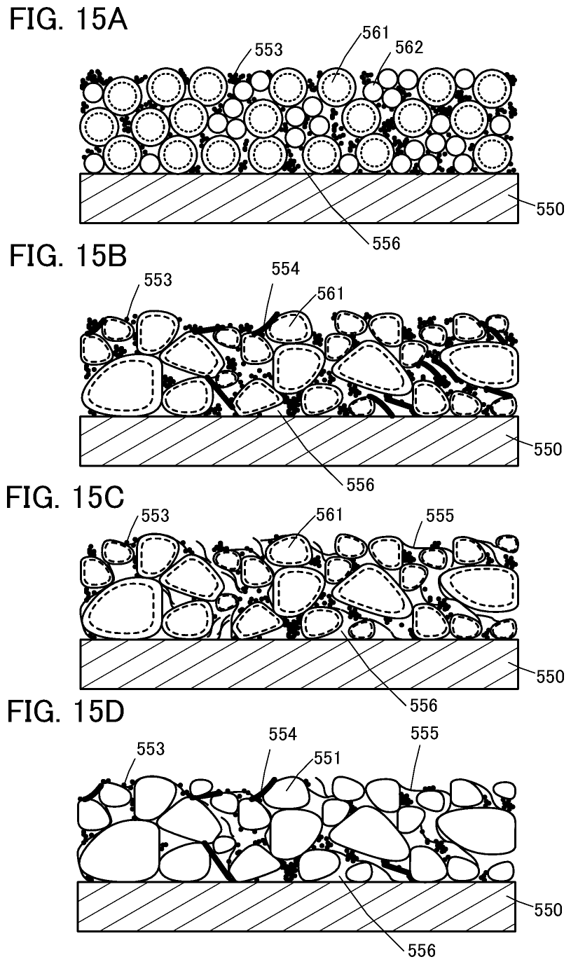

The positive electrode includes a positive electrode active material layer and a positive electrode current collector. FIG. 15A illustrates an example of a schematic cross-sectional view of the positive electrode. The cross section in FIG. 15A is one after the secondary battery is manufactured, in which a space between a plurality of active materials 561 is filled with an electrolyte 556. Note that a void is sometimes generated when the space between the plurality of active materials 561 is not filled well.

A current collector 550 is metal foil, and the positive electrode is formed by applying slurry onto the metal foil and drying the slurry. Pressing may be performed after drying. The positive electrode is a component obtained by forming an active material layer over the current collector 550.

Slurry refers to a material solution that is used to form an active material layer over the current collector 550 and includes at least an active material, a binder, and a solvent, preferably also a conductive additive mixed therewith. Slurry may also be referred to as slurry for an electrode or active material slurry; in some cases, slurry for forming a positive electrode active material layer is referred to as slurry for a positive electrode, and slurry for forming a negative electrode active material layer is referred to as slurry for a negative electrode.

A conductive additive is also referred to as a conductivity-imparting agent or a conductive material, and a carbon material is used. A conductive additive is attached between a plurality of active materials, whereby the plurality of active materials are electrically connected to each other, and the conductivity increases. Note that the term “attach” refers not only to a state where an active material and a conductive additive are physically in close contact with each other, and includes, for example, the following concepts: the case where covalent bonding occurs, the case where bonding with the Van der Waals force occurs, the case where a conductive additive covers part of the surface of an active material, the case where a conductive additive is embedded in surface roughness of an active material, and the case where an active material and a conductive additive are electrically connected to each other without being in contact with each other.

Typical examples of the carbon material used as the conductive additive include carbon black (e.g., furnace black, acetylene black, and graphite).

In FIG. 15A, acetylene black 553 is shown as the conductive additive. FIG. 15A shows an example in which second active materials 562 having a smaller particle diameter than a particle of a first active material are mixed. The positive electrode in which particles with different particle sizes are mixed can have high density. Note that the first active material particle corresponds to an active material 561 in FIG. 15A.

Note that the expression “the first active material particle has a core-shell structure (also referred to as a core-shell-type structure)” is used in some cases.

In the first active material particle, NCM is used for a core, and NCM with a composition different from that of the core is used for a shell. For the first active material particle, a lithium composite oxide using cobalt, nickel, and manganese such as a NiCoMn-based material (also referred to as NCM) represented by LiNiₓCo_{y}Mn_{z}O₂ (x>0, y>0, z>0, 0.8<x+y+z<1.2) can be used, for example.

Specifically, 0.1x<y<8x and 0.1x<z<8x are preferably satisfied, for example. For example, x, y, and z preferably satisfy x:y:z=1:1:1 or the neighborhood thereof. Alternatively, for example, x, y, and z preferably satisfy x:y:z=5:2:3 or the neighborhood thereof. Alternatively, for example, x, y, and z preferably satisfy x:y:z=8:1:1 or the neighborhood thereof. Alternatively, for example, x, y, and z preferably satisfy x:y:z=9:0.5:0.5 or the neighborhood thereof. Alternatively, for example, x, y, and z preferably satisfy x:y:z=6:2:2 or the neighborhood thereof. Alternatively, for example, x, y, and z preferably satisfy x:y:z=1:4:1 or the neighborhood thereof. The first active material particle may have a structure in which LCO is used for its core and NCM is used for its shell. Alternatively, LCO may be used for its core and LFP may be used for its shell. Note that LCO is an abbreviation for lithium cobalt oxide (LiCoO₂), and LFP is an abbreviation for lithium iron phosphate (LiFePO₄).

In the positive electrode of the secondary battery, a binder (a resin) is mixed in order to fix the current collector 550 such as metal foil and the active material. The binder is also referred to as a binding agent. Since the binder is a high molecular material, a large amount of the binder lowers the proportion of the active material in the positive electrode, thereby reducing the discharge capacity of the secondary battery. Therefore, the amount of the binder mixed is reduced to a minimum. In FIG. 15A, a region that is not filled with the active material 561, the second active material 562, or the acetylene black 553 represents the electrolyte 556, a space, or a binder. The volumes of the active material 561 and the second active material 562 sometimes change in charging and discharging; however, a fluorine-containing electrolyte 556 such as fluorinated carbonate ester between the active materials 561 or the second active materials 562 maintains smoothness and inhibits a crack even when the volumes change in charging and discharging, so that an effect of increasing the cycle performance is obtained. It is important that an organic compound containing fluorine exists between a plurality of active materials included in the positive electrode.

In FIG. 15A, the boundary between the core region and the shell region of the active material 561 is indicated by a dotted line in the active material 561. Although FIG. 15A shows an example in which the active material 561 has a spherical shape, there is no particular limitation and other various shapes can be employed. The cross-sectional shape of the active material 561 may be an ellipse, a rectangle, a trapezoid, a pyramid, a quadrilateral with rounded corners, or an asymmetrical shape.

FIG. 15B shows an example in which the active materials 561 have various shapes. FIG. 15B shows the example different from that in FIG. 15A.

In the positive electrode in FIG. 15B, graphene 554 is used as a carbon material used as the conductive additive.

Graphene, which has electrically, mechanically, or chemically marvelous characteristics, is a carbon material that is expected to be applied to a variety of fields, such as field-effect transistors and solar batteries.

In FIG. 15B, a positive electrode active material layer including the active material 561, the graphene 554, and the acetylene black 553 is formed over the current collector 550.

In the step of mixing the graphene 554 and the acetylene black 553 to obtain an electrode slurry, the weight of mixed carbon black is preferably 1.5 times to 20 times, further preferably 2 times to 9.5 times the weight of graphene.

When the graphene 554 and the acetylene black 553 are mixed in the above range, the acetylene black 553 can be dispersed uniformly and less likely to be aggregated at the time of preparing the slurry. Furthermore, when the graphene 554 and the acetylene black 553 are mixed in the above range, the electrode density can be higher than that of an electrode using only the acetylene black 553 as a conductive additive. As the electrode density is higher, the capacity per unit weight can be higher. Specifically, the density of the positive electrode active material layer measured by gravimetry can be higher than 3.5 g/cc. In addition, it is preferable that the first active material particle be used for the positive electrode and the graphene 554 and the acetylene black 553 be mixed in the above range, in which case a synergy effect for higher capacity of the secondary battery can be expected.

The electrode density is lower than that of a positive electrode containing only graphene as a conductive additive, but when a first carbon material (graphene) and a second carbon material (acetylene black) are mixed in the above range, fast charge can be achieved. In addition, it is preferable that the electrolyte 556 described in Embodiment 1 be used to increase the capacity of the secondary battery, in which case a synergistic effect of increasing the stability of the secondary battery can be expected.

The above features are advantageous for secondary batteries for vehicles.

When a vehicle becomes heavier with an increasing number of secondary batteries, more energy is needed to move the vehicle, which shortens the driving range. With the use of a high-density secondary battery, the driving range of the vehicle can be maintained with almost no change in the total weight of a vehicle including a secondary battery having the same weight.

Since electric power is needed to charge the secondary battery with higher capacity in the vehicle, it is desirable to end charging fast. What is called a regenerative charging, in which electric power is temporarily generated when the vehicle is braked and the electric power is used for charging, is performed under high rate charging conditions; thus, a secondary battery for a vehicle is desired to have favorable rate characteristics.

When the first active material particle is used in the positive electrode, the mixing ratio of acetylene black to graphene is made within an optimal range, and the electrolyte described in Embodiment 1 is used, whereby a secondary battery for a vehicle, which has a wide range of temperatures, can be obtained.

This structure is also effective in a portable information terminal, and using the first active material particle for the positive electrode and setting the mixing ratio of acetylene black to graphene in the optimal range enable a small secondary battery with high capacity. Setting the mixing ratio of acetylene black to graphene in the optimal range also enables fast charge of a portable information terminal.

In FIG. 15B, the boundary between the core region and the shell region of the active material 561 is indicated by a dotted line in the active material 561. In FIG. 15B, the region that is not filled with the active material 561, the graphene 554, or the acetylene black 553 represents the electrolyte 556, a space, or a binder. A space is required for the electrolyte 556 to penetrate the positive electrode; too many spaces lower the electrode density, too few spaces do not allow the electrolyte 556 to penetrate the positive electrode, and a space that remains after the secondary battery is completed lowers the efficiency. The volume of the active material 561 sometimes changes in charging and discharging; however, a fluorine-containing electrolyte 556 such as fluorinated carbonate ester between the plurality of active materials 561 maintains smoothness and inhibits a crack even when the volume changes in charging and discharging, so that an effect of increasing the cycle performance is obtained. It is important that an organic compound containing fluorine exists between a plurality of active materials included in a positive electrode.

Using the first active material particle for the positive electrode and setting the mixing ratio of acetylene black and graphene in the optimal range enable both higher electrode density and formation of an appropriate space needed for ion conduction, whereby a secondary battery which has high energy density and favorable output characteristics can be obtained.

FIG. 15C shows an example of a positive electrode in which a carbon nanotube 555 is used instead of graphene. FIG. 15C shows the example different from that in FIG. 15B. With the use of the carbon nanotube 555, aggregation of carbon black such as the acetylene black 553 can be prevented and the dispersibility can be increased.

In FIG. 15C, the region that is not filled with the active material 561, the carbon nanotube 555, or the acetylene black 553 represents the electrolyte 556, a space, or a binder. The volume of the active material 561 sometimes changes in charging and discharging; however, a fluorine-containing electrolyte 556 such as fluorinated carbonate ester between the plurality of active materials 561 maintains smoothness and inhibits a crack even when the volume changes in charging and discharging, so that an effect of increasing the cycle performance is obtained. It is important that an organic compound containing fluorine exists between a plurality of active materials included in a positive electrode.

FIG. 15D shows another example of a positive electrode. FIG. 15D shows an example in which an active material 551 does not have the core-shell structure. FIG. 15D shows an example in which the carbon nanotube 555 is used in addition to the graphene 554. With the use of both the graphene 554 and the carbon nanotube 555, aggregation of carbon black such as the acetylene black 553 can be prevented and the dispersibility can be further increased.

In FIG. 15D, the region that is not filled with the active material 551, the carbon nanotube 555, the graphene 554, or the acetylene black 553 represents the electrolyte 556, a space, or a binder. The volume of the active material 551 sometimes changes in charging and discharging; however, a fluorine-containing electrolyte such as fluorinated carbonate ester between the plurality of active materials 551 maintains smoothness and inhibits a crack even when the volume changes in charging and discharging, so that an effect of increasing the cycle performance is obtained. It is important that an organic compound containing fluorine exists between a plurality of active materials included in a positive electrode.

A secondary battery can be manufactured by using any one of the positive electrodes in FIG. 15A, FIG. 15B, FIG. 15C, and FIG. 15D; setting, in a container (e.g., an exterior body or a metal can) or the like, a stack in which a separator is provided over the positive electrode and a negative electrode is provided over the separator; and filling the container with an electrolyte.

Although the above structure is an example of a secondary battery using the electrolyte 556, one embodiment of the present invention is not particularly limited thereto. For example, a semi-solid-state battery or an all-solid-state battery can also be manufactured.

In this specification and the like, a semi-solid-state battery refers to a battery in which at least one of an electrolyte layer, a positive electrode, and a negative electrode includes a semi-solid-state material. The term “semi-solid-state” here does not mean that the proportion of a solid-state material is 50%. The term “semi-solid-state” means having properties of a solid, such as a small volume change, and also having some of properties close to those of a liquid, such as flexibility. A single material or a plurality of materials can be used as long as the above properties are satisfied. For example, a porous solid-state material infiltrated with a liquid material may be used.

In this specification and the like, a polymer electrolyte secondary battery refers to a secondary battery in which an electrolyte layer between a positive electrode and a negative electrode contains a polymer. Polymer electrolyte secondary batteries include a dry (or intrinsic) polymer electrolyte battery and a polymer gel electrolyte battery. A polymer electrolyte secondary battery may be referred to as a semi-solid-state battery.

A semi-solid-state battery manufactured using the positive electrode active material 811 is a secondary battery having high charge and discharge capacity. The semi-solid-state battery can have high charge and discharge voltages. Alternatively, a highly safe or reliable semi-solid-state battery can be provided.

### [Negative Electrode]

The negative electrode includes a negative electrode active material layer and a negative electrode current collector. The negative electrode active material layer may include a conductive additive and a binding agent.

### <Negative Electrode Active Material>

As the negative electrode active material, for example, an alloy-based material, a carbon-based material, or the like can be used. The negative electrode active material used for the secondary battery of one embodiment of the present invention particularly preferably contains fluorine as a halogen. Fluorine has high electronegativity, and the negative electrode active material containing fluorine in its surface portion may have an effect of facilitating extraction of the solvating solvent at the surface of the negative electrode active material.

As the negative electrode active material, an element that enables charge and discharge reactions by alloying and dealloying reactions with lithium can be used. For example, a material containing at least one of silicon, tin, gallium, aluminum, germanium, lead, antimony, bismuth, silver, zinc, cadmium, indium, and the like can be used. Such elements have higher capacity than carbon. In particular, silicon has a high theoretical capacity of 4200 mAh/g. For this reason, silicon is preferably used as the negative electrode active material. Alternatively, a compound containing any of the above elements may be used. For example, SiO, Mg₂Si, Mg₂Ge, SnO, SnO₂, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn are given. Here, an element that enables charge and discharge reactions by alloying and dealloying reactions with lithium, a compound containing the element, and the like may be referred to as an alloy-based material.

In this specification and the like, SiO refers to silicon monoxide, for example. Note that SiO can alternatively be expressed as SiOₓ Here, it is preferred that x be 1 or have an approximate value of 1. For example, x is preferably more than or equal to 0.2 and less than or equal to 1.5, and preferably more than or equal to 0.3 and less than or equal to 1.2.

As the carbon-based material, graphite, graphitizing carbon (soft carbon), non-graphitizing carbon (hard carbon), carbon nanotube, graphene, carbon black, or the like can be used. Such a carbon-based material preferably contains fluorine. A carbon-based material containing fluorine can also be referred to as a particulate or fibrous fluorocarbon material. In the case where the carbon-based material is subjected to measurement by X-ray photoelectron spectroscopy, the concentration of fluorine is preferably higher than or equal to 1 atomic % with respect to the total concentration of fluorine, oxygen, lithium, and carbon.

Although the volume of a negative electrode active material sometimes changes in charging and discharging, an organic compound containing fluorine, such as fluorinated carbonate ester, placed between negative electrode active materials maintains smoothness and inhibits a crack even when the volume changes in charging and discharging, so that an effect of increasing cycle performance is obtained. It is important that an organic compound containing fluorine exists between a plurality of negative electrode active materials.

Examples of graphite include artificial graphite and natural graphite. Examples of artificial graphite include mesocarbon microbeads (MCMB), coke-based artificial graphite, and pitch-based artificial graphite. Here, as artificial graphite, spherical graphite having a spherical shape can be used. For example, MCMB is preferable because it may have a spherical shape. Moreover, MCMB may be preferable because it can relatively easily have a small surface area. Examples of natural graphite include flake graphite and spherical natural graphite.

Graphite has a low potential substantially equal to that of a lithium metal (higher than or equal to 0.05 V and lower than or equal to 0.3 V vs. Li/Li⁺) when lithium ions are inserted into the graphite (while a lithium-graphite intercalation compound is generated). For this reason, a lithium-ion secondary battery can have a high operating voltage. In addition, graphite is preferred because of its advantages such as a relatively high capacity per unit volume, relatively small volume expansion, low cost, and higher level of safety than that of a lithium metal.

As the negative electrode active material, an oxide such as titanium dioxide (TiO₂), lithium titanium oxide (Li₄Ti₅O₁₂), a lithium-graphite intercalation compound (LiₓC₆), niobium pentoxide (Nb₂O₅), tungsten oxide (WO₂), or molybdenum oxide (MoO₂) can be used.

Alternatively, as the negative electrode active material, Li₃₋ₓMₓN (M=Co, Ni, Cu) with a Li₃N structure, which is a composite nitride containing lithium and a transition metal, can be used. For example, Li_{2.6}Co_{0.4}N₃ is preferable because of high charge and discharge capacity (900 mAh/g and 1890 mAh/cm³).

A composite nitride containing lithium and a transition metal is preferably used, in which case lithium ions are contained in the negative electrode active material and thus the negative electrode active material can be used in combination with a positive electrode active material that does not contain lithium ions, such as V₂O₅ or Cr₃O₈. Note that in the case of using a material containing lithium ions as a positive electrode active material, the composite nitride containing lithium and a transition metal can be used as the negative electrode active material by extracting the lithium ions contained in the positive electrode active material in advance.

Alternatively, a material that causes a conversion reaction can be used as the negative electrode active material. For example, a transition metal oxide that does not form an alloy with lithium, such as cobalt oxide (CoO), nickel oxide (NiO), and iron oxide (FeO), may be used as the negative electrode active material. A conversion reaction also occurs in oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃.

[Conductive Agent Modified with Fluorine].

Here, in the negative electrode of one embodiment of the present invention, the conductive agent is preferably modified with fluorine. For example, as the conductive agent, a material obtained by modification of the above-described conductive agent with fluorine can be used.

The conductive agent can be modified with fluorine through treatment or heat treatment using a fluorine-containing gas or plasma treatment in a fluorine-containing gas atmosphere, for example. As the fluorine-containing gas, for example, a fluorine gas or a lower hydrofluorocarbon gas such as fluoromethane (CF₄) can be used.

Alternatively, the conductive agent may be modified with fluorine through immersion in a solution containing hydrofluoric acid, tetrafluoroboric acid, hexafluorophosphoric acid, or the like or a solution containing a fluorine-containing ether compound, for example.

Modification of the conductive agent with fluorine is expected to stabilize the structure and inhibit a side reaction in charging and discharging process of a secondary battery. The inhibition of the side reaction can improve charge and discharge efficiency. In addition, a decrease in capacity caused by repetitive charging and discharging can be inhibited. Thus, when the negative electrode of one embodiment of the present invention includes a conductive agent that is modified with fluorine, an excellent secondary battery can be achieved.

In some cases, stabilization of the structure of the conductive agent stabilizes conductive characteristics, leading to high output characteristics.

### <Negative Electrode Current Collector>

For the negative electrode current collector, a material similar to that of the positive electrode current collector can be used. Note that a material that is not alloyed with carrier ions of lithium or the like is preferably used for the negative electrode current collector.

### [Separator]

A separator is positioned between the positive electrode and the negative electrode. The separator can be formed using, for example, a fiber containing cellulose, such as paper, nonwoven fabric, glass fiber, ceramics, or synthetic fiber containing nylon (polyamide), vinylon (polyvinyl alcohol-based fiber), polyester, acrylic, polyolefin, or polyurethane. The separator is preferably processed into a bag-like shape to enclose one of the positive electrode and the negative electrode.

The separator may have a multilayer structure. For example, an organic material film of polypropylene, polyethylene, or the like can be coated with a ceramic-based material, a fluorine-based material, a polyamide-based material, a mixture thereof, or the like. Examples of the ceramic-based material include aluminum oxide particles and silicon oxide particles. Examples of the fluorine-based material include PVDF and polytetrafluoroethylene. Examples of the polyamide-based material include nylon and aramid (meta-based aramid and para-based aramid).

When the separator is coated with the ceramic-based material, the oxidation resistance is improved; hence, deterioration of the separator in charging and discharging at high voltage can be inhibited and thus the reliability of the secondary battery can be improved. When the separator is coated with the fluorine-based material, the separator is easily brought into close contact with an electrode, resulting in high output characteristics. When the separator is coated with the polyamide-based material, in particular, aramid, the safety of the secondary battery is improved because heat resistance is improved.

For example, both surfaces of a polypropylene film may be coated with a mixed material of aluminum oxide and aramid. Alternatively, a surface of a polypropylene film that is in contact with the positive electrode may be coated with a mixed material of aluminum oxide and aramid, and a surface of the polypropylene film that is in contact with the negative electrode may be coated with the fluorine-based material.

With the use of a separator having a multilayer structure, the capacity per volume of the secondary battery can be increased because the safety of the secondary battery can be maintained even when the total thickness of the separator is small.

### [Electrolyte]

The compound containing fluorine described in Embodiment 1 is used as one of the components of the electrolyte, and a mixture of the component and an acyclic ester, specifically, a mixture of the component and diethyl carbonate is used as the electrolyte.

Furthermore, an additive agent such as vinylene carbonate, propane sultone (PS), tert-butylbenzene (TBB), lithium bis(oxalate)borate (LiBOB), or a dinitrile compound such as succinonitrile or adiponitrile may be added to the electrolyte. The concentration of the additive in the whole electrolyte is, for example, higher than or equal to 0.1 vol. % and lower than 5 vol. %.

Furthermore, a polymer gel electrolyte may be used. When a polymer gel electrolyte is used, safety against liquid leakage and the like is improved. Moreover, a secondary battery can be thinner and more lightweight.

As a polymer that undergoes gelation, a silicone gel, an acrylic gel, an acrylonitrile gel, a polyethylene oxide-based gel, a polypropylene oxide-based gel, a fluorine-based polymer gel, or the like can be used. Examples include a polymer having a polyalkylene oxide structure, such as polyethylene oxide (PEO); PVDF; polyacrylonitrile; and a copolymer containing any of them. For example, PVDF-HFP, which is a copolymer of PVDF and hexafluoropropylene (HFP), can be used. The formed polymer may be porous.

This embodiment can be implemented in appropriate combination with any of the other embodiments.

### Embodiment 3

In this embodiment, examples of shapes of several types of secondary batteries including a positive electrode or a negative electrode formed by the manufacturing method described in the foregoing embodiment will be described.

### [Coin-Type Secondary Battery]

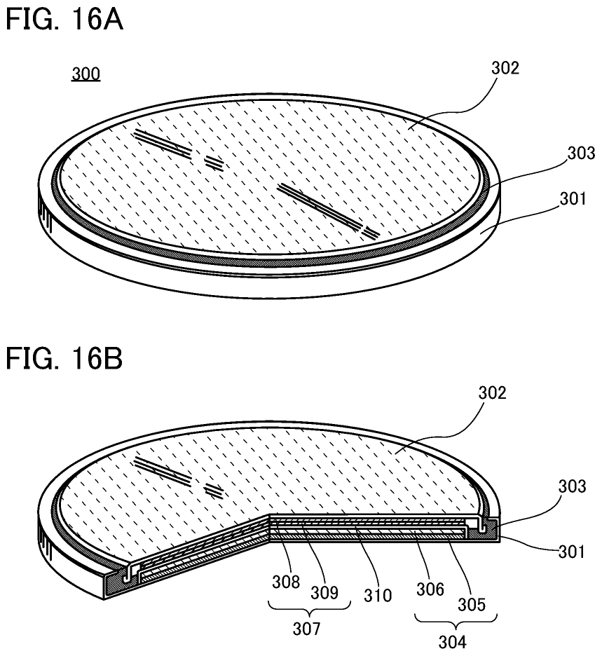

An example of a coin-type secondary battery is described. FIG. 16A is an external view of a coin-type (single-layer flat type) secondary battery, and FIG. 16B is a cross-sectional view thereof.

In a coin-type secondary battery 300, a positive electrode can 301 doubling as a positive electrode terminal and a negative electrode can 302 doubling as a negative electrode terminal are insulated from each other and sealed by a gasket 303 made of polypropylene or the like. A positive electrode 304 includes a positive electrode current collector 305 and a positive electrode active material layer 306 provided in contact with the positive electrode current collector 305. A negative electrode 307 includes a negative electrode current collector 308 and a negative electrode active material layer 309 provided in contact with the negative electrode current collector 308.

Note that only one surface of each of the positive electrode 304 and the negative electrode 307 used for the coin-type secondary battery 300 is provided with an active material layer.

For the positive electrode can 301 and the negative electrode can 302, a metal having corrosion resistance to an electrolyte, such as nickel, aluminum, or titanium, an alloy of such a metal, or an alloy of such a metal and another metal (e.g., stainless steel) can be used. The positive electrode can 301 and the negative electrode can 302 are preferably covered with nickel, aluminum, or the like in order to prevent corrosion due to the electrolyte. The positive electrode can 301 and the negative electrode can 302 are electrically connected to the positive electrode 304 and the negative electrode 307, respectively.

The coin-type secondary battery 300 is manufactured in the following manner: the negative electrode 307, the positive electrode 304, and the separator 310 are immersed in the electrolyte; as illustrated in FIG. 16B, the positive electrode 304, the separator 310, the negative electrode 307, and the negative electrode can 302 are stacked in this order with the positive electrode can 301 positioned at the bottom; and then the positive electrode can 301 and the negative electrode can 302 are subjected to pressure bonding with the gasket 303 therebetween.

When the particle of the first active material is used in the positive electrode 304 to obtain the secondary battery including the electrolyte described in Embodiment 1, the coin-type secondary battery 300 can have high capacity, high charge and discharge capacity, and excellent cycle performance.

### [Cylindrical Secondary Battery]

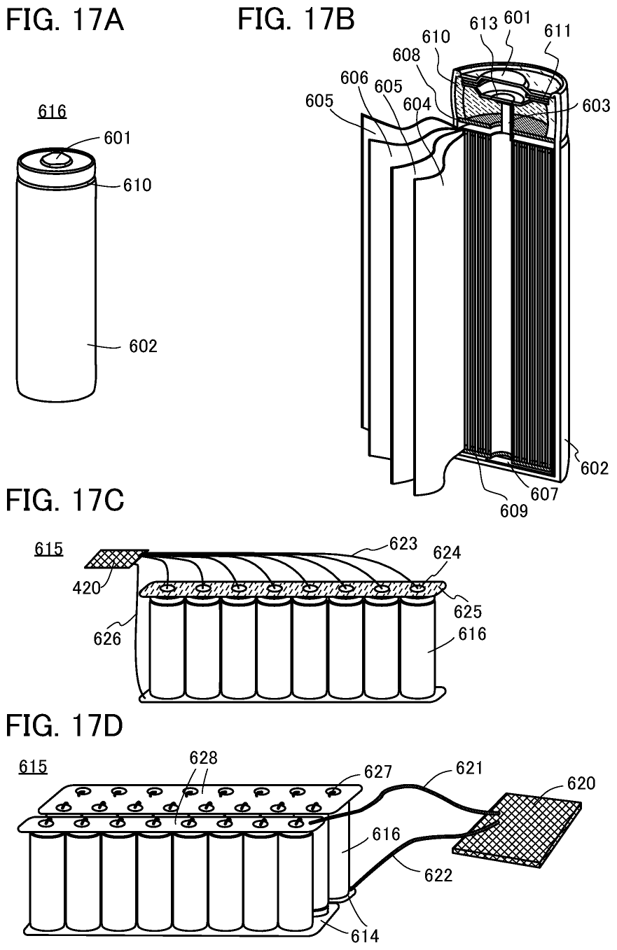

An example of a cylindrical secondary battery is described with reference to FIG. 17A. As illustrated in FIG. 17A, a cylindrical secondary battery 616 includes a positive electrode cap (battery cap) 601 on the top surface and a battery can (outer can) 602 on the side surface and bottom surface. The battery can (outer can) 602 is formed using a metal material and has an excellent barrier property against water permeation and an excellent gas barrier property. The positive electrode cap 601 and the battery can (outer can) 602 are insulated from each other by a gasket (insulating gasket) 610.

FIG. 17B schematically illustrates a cross section of a cylindrical secondary battery. The cylindrical secondary battery illustrated in FIG. 17B includes the positive electrode cap (battery cap) 601 on the top surface and the battery can (outer can) 602 on the side surface and the bottom surface. The positive electrode cap and the battery can (outer can) 602 are insulated from each other by the gasket (insulating gasket) 610.

Inside the battery can 602 having a hollow cylindrical shape, a battery element in which a strip-like positive electrode 604 and a strip-like negative electrode 606 are wound with a strip-like separator 605 located therebetween is provided. Although not illustrated, the battery element is wound around a center pin. One end of the battery can 602 is close and the other end thereof is open. For the battery can 602, a metal having corrosion resistance to an electrolyte, such as nickel, aluminum, or titanium, an alloy of such a metal, or an alloy of such a metal and another metal (e.g., stainless steel) can be used. The battery can 602 is preferably covered with nickel, aluminum, or the like in order to prevent corrosion due to the electrolyte. Inside the battery can 602, the battery element in which the positive electrode, the negative electrode, and the separator are wound is provided between a pair of insulating plates 608 and 609 that face each other. The inside of the battery can 602 provided with the battery element is filled with an electrolyte (not illustrated). An electrolyte similar to that for the coin-type secondary battery can be used.

Since a positive electrode and a negative electrode that are used for a cylindrical storage battery are wound, active materials are preferably formed on both surfaces of a current collector.

The electrolyte obtained in Embodiment 1 and the positive electrode active material obtained in Embodiment 2 are used, whereby the cylindrical secondary battery 616 can have high capacity, high charge and discharge capacity, and excellent cycle performance.

A positive electrode terminal (positive electrode current collecting lead) 603 is connected to the positive electrode 604, and a negative electrode terminal (negative electrode current collecting lead) 607 is connected to the negative electrode 606. Both the positive electrode terminal 603 and the negative electrode terminal 607 can be formed using a metal material such as aluminum. The positive electrode terminal 603 and the negative electrode terminal 607 are resistance-welded to a safety valve mechanism 613 and the bottom of the battery can 602, respectively. The safety valve mechanism 613 is electrically connected to the positive electrode cap 601 through a PTC element (Positive Temperature Coefficient) 611. The safety valve mechanism 613 cuts off electrical connection between the positive electrode cap 601 and the positive electrode 604 when the internal pressure of the battery exceeds a predetermined threshold. The PTC element 611, which is a thermally sensitive resistor whose resistance increases as temperature rises, limits the amount of current by increasing the resistance, in order to prevent abnormal heat generation. Barium titanate (BaTiO₃)-based semiconductor ceramic or the like can be used for the PTC element.

FIG. 17C shows an example of a power storage system 615. The power storage system 615 includes a plurality of secondary batteries 616. The positive electrodes of the secondary batteries are in contact with and electrically connected to conductors 624 isolated by an insulator 625. The conductor 624 is electrically connected to a control circuit 620 through a wiring 623. The negative electrodes of the secondary batteries are electrically connected to the control circuit 620 through a wiring 626. As the control circuit 620, a charging and discharging control circuit for performing charging, discharging, and the like and a protection circuit for preventing overcharging or overdischarging can be used.

FIG. 17D shows an example of the power storage system 615. The power storage system 615 includes a plurality of secondary batteries 616, and the plurality of secondary batteries 616 are sandwiched between a conductive plate 628 and a conductive plate 614. The plurality of secondary batteries 616 are electrically connected to the conductive plate 628 and the conductive plate 614 through a wiring 627. The plurality of secondary batteries 616 may be connected in parallel, connected in series, or connected in series after being connected in parallel. With the power storage system 615 including the plurality of secondary batteries 616, large electric power can be extracted.

The plurality of secondary batteries 616 may be connected in series after being connected in parallel.

A temperature control device may be provided between the plurality of secondary batteries 616. The secondary batteries 616 can be cooled with the temperature control device when overheated, whereas the secondary batteries 616 can be heated with the temperature control device when cooled too much. Thus, the performance of the power storage system 615 is less likely to be influenced by the outside temperature.

In FIG. 17D, the power storage system 615 is electrically connected to the control circuit 620 through a wiring 621 and a wiring 622. The wiring 621 is electrically connected to the positive electrodes of a plurality of secondary batteries 600 through the conductive plate 628.

The wiring 622 is electrically connected to the negative electrodes of the plurality of secondary batteries 600 through the conductive plate 614.

### [Other Structure Examples of Secondary Battery]

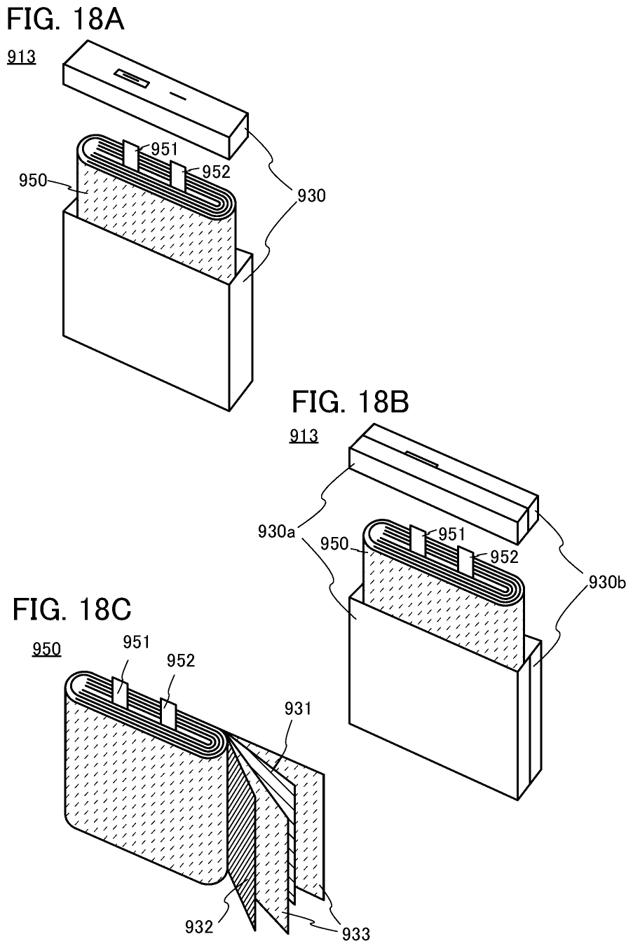

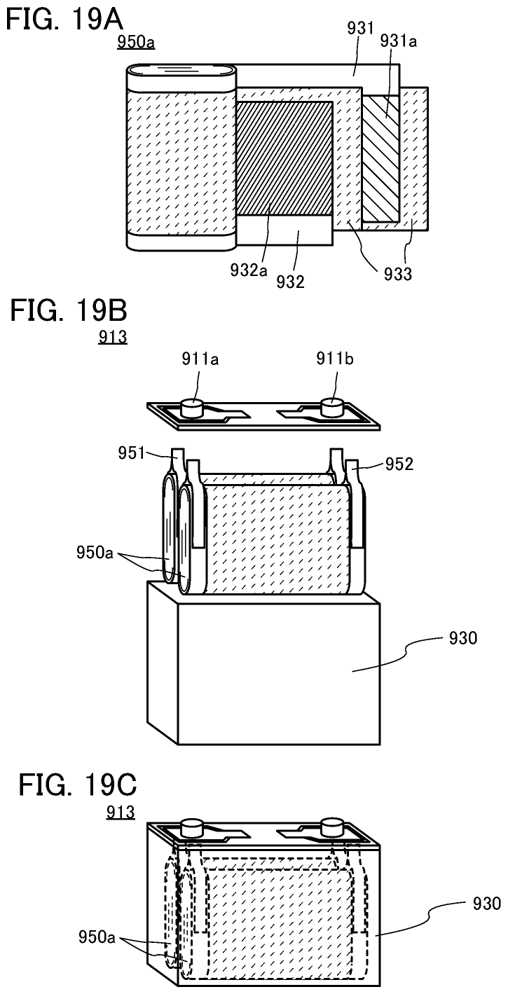

Structure examples of secondary batteries are described with reference to FIG. 18 and FIG. 19.

A secondary battery 913 illustrated in FIG. 18A includes a wound body 950 provided with a terminal 951 and a terminal 952 inside a housing 930. The wound body 950 is immersed in an electrolyte inside the housing 930. The terminal 952 is in contact with the housing 930. The use of an insulator or the like inhibits contact between the terminal 951 and the housing 930. Note that in FIG. 18A, the housing 930 divided into pieces is illustrated for convenience; however, in the actual structure, the wound body 950 is covered with the housing 930, and the terminal 951 and the terminal 952 extend to the outside of the housing 930. For the housing 930, a metal material (e.g., aluminum) or a resin material can be used.

Note that as illustrated in FIG. 18B, the housing 930 in FIG. 18A may be formed using a plurality of materials. For example, in the secondary battery 913 illustrated in FIG. 18B, a housing 930a and a housing 930b are attached to each other, and the wound body 950 is provided in a region surrounded by the housing 930a and the housing 930b.

For the housing 930a, an insulating material such as an organic resin can be used. In particular, when a material such as an organic resin is used for the side on which an antenna is formed, blocking of an electric field by the secondary battery 913 can be inhibited. When an electric field is not significantly blocked by the housing 930a, an antenna may be provided inside the housing 930a. For the housing 930b, a metal material can be used, for example.

FIG. 18C illustrates the structure of the wound body 950. The wound body 950 includes a negative electrode 931, a positive electrode 932, and separators 933. The wound body 950 is obtained by winding a sheet of a stack in which the negative electrode 931 and the positive electrode 932 overlap with the separator 933 therebetween. Note that a plurality of stacks each including the negative electrode 931, the positive electrode 932, and the separators 933 may be further stacked.

As illustrated in FIG. 19, the secondary battery 913 may include a wound body 950a. The wound body 950a illustrated in FIG. 19A includes the negative electrode 931, the positive electrode 932, and the separators 933. The negative electrode 931 includes a negative electrode active material layer 931a. The positive electrode 932 includes a positive electrode active material layer 932a.

The electrolyte obtained in Embodiment 1 is used and the positive electrode active material 811 obtained in Embodiment 2 is used for the positive electrode 932, whereby the secondary battery 913 can have high capacity, high charge and discharge capacity, and excellent cycle performance.

The separator 933 has a larger width than the negative electrode active material layer 931a and the positive electrode active material layer 932a, and is wound to overlap the negative electrode active material layer 931a and the positive electrode active material layer 932a. In terms of safety, the width of the negative electrode active material layer 931a is preferably larger than that of the positive electrode active material layer 932a. The wound body 950a having such a shape is preferable because of its high degree of safety and high productivity.

As illustrated in FIG. 19A and FIG. 19B, the negative electrode 931 is electrically connected to the terminal 951. The terminal 951 is electrically connected to a terminal 911a. The positive electrode 932 is electrically connected to the terminal 952. The terminal 952 is electrically connected to a terminal 911b.

As illustrated in FIG. 19C, the wound body 950a and an electrolyte are covered with the housing 930, whereby the secondary battery 913 is completed. The housing 930 is preferably provided with a safety valve, an overcurrent protection element, and the like. In order to prevent the battery from exploding, a safety valve is a valve to be released when the internal pressure of the housing 930 reaches a predetermined pressure.

As illustrated in FIG. 19B, the secondary battery 913 may include a plurality of wound bodies 950a. The use of the plurality of wound bodies 950a enables the secondary battery 913 to have higher charge and discharge capacity. The description of the secondary battery 913 illustrated in FIG. 18A to FIG. 18C can be referred to for the other components of the secondary battery 913 illustrated in FIG. 19A and FIG. 19B.

### <Laminated Secondary Battery>

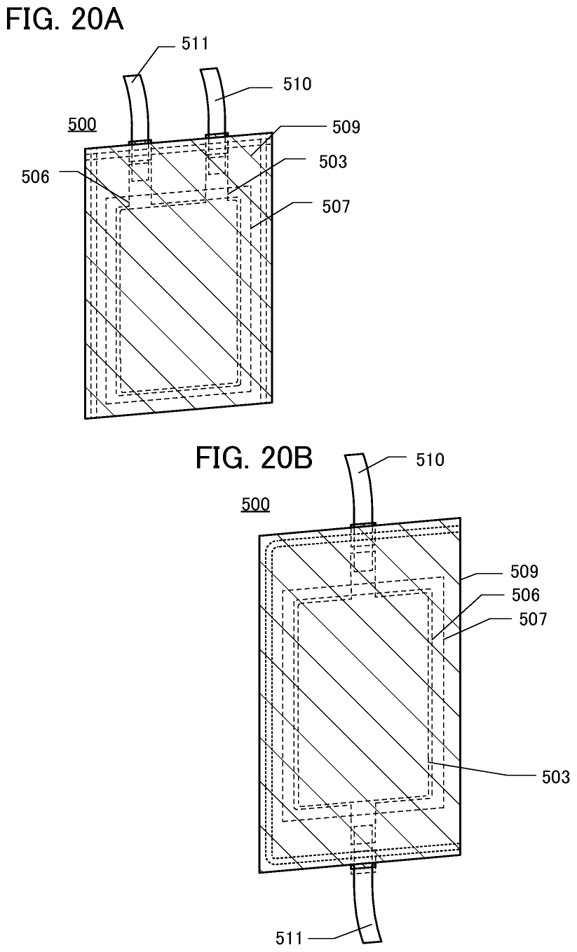

Next, examples of the appearance of a laminated secondary battery are shown in FIG. 20A and FIG. 20B. FIG. 20A and FIG. 20B each include a positive electrode 503, a negative electrode 506, a separator 507, an exterior body 509, a positive electrode lead electrode 510, and a negative electrode lead electrode 511.

FIG. 20A illustrates the appearance of the positive electrode 503 and the negative electrode 506. The positive electrode 503 includes a positive electrode current collector 501, and a positive electrode active material layer 502 is formed on a surface of the positive electrode current collector 501. The positive electrode 503 also includes a region where the positive electrode current collector 501 is partly exposed (hereinafter referred to as a tab region). The negative electrode 506 includes a negative electrode current collector 504, and a negative electrode active material layer 505 is formed on a surface of the negative electrode current collector 504. The negative electrode 506 also includes a region where the negative electrode current collector 504 is partly exposed, that is, a tab region. The areas and the shapes of the tab regions included in the positive electrode and the negative electrode are not limited to the examples shown in FIG. 20A.

### <Method for Manufacturing Laminated Secondary Battery>

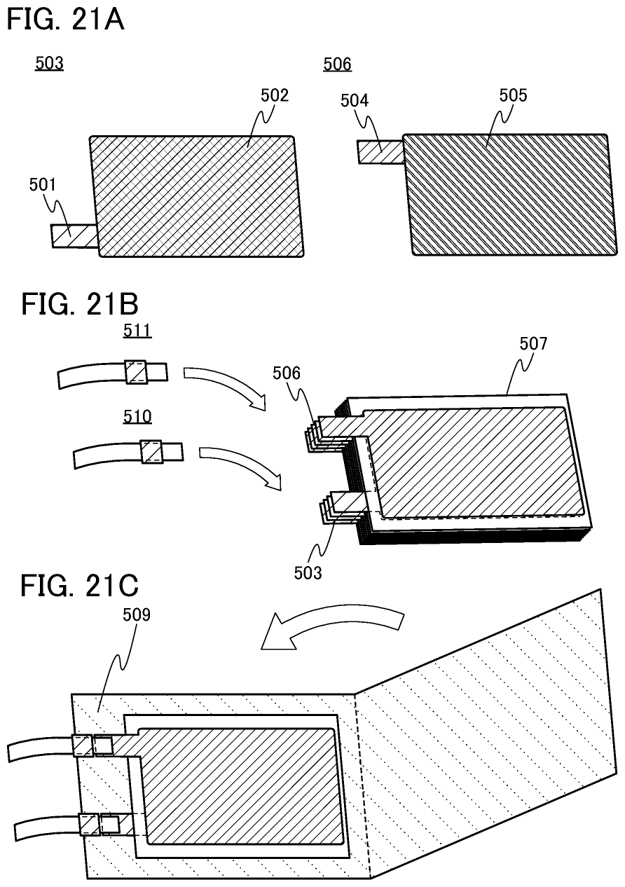

Here, an example of a method for manufacturing the laminated secondary battery whose external view is shown in FIG. 20A will be described with reference to FIG. 21B and FIG. 21C.

First, the negative electrode 506, the separator 507, and the positive electrode 503 are stacked. FIG. 21B illustrates the negative electrodes 506, the separators 507, and the positive electrodes 503 that are stacked. Here, an example in which five negative electrodes and four positive electrodes are used is shown. The component can also be referred to as a stack including the negative electrodes, the separators, and the positive electrodes. Next, the tab regions of the positive electrodes 503 are bonded to each other, and the positive electrode lead electrode 510 is bonded to the tab region of the positive electrode on the outermost surface. The bonding can be performed by ultrasonic welding, for example. In a similar manner, the tab regions of the negative electrodes 506 are bonded to each other, and the negative electrode lead electrode 511 is bonded to the tab region of the negative electrode on the outermost surface.

Then, the negative electrodes 506, the separators 507, and the positive electrodes 503 are placed over the exterior body 509.

Subsequently, the exterior body 509 is folded along a portion shown by a dashed line, as illustrated in FIG. 21C. Then, the outer edges of the exterior body 509 are bonded to each other. The bonding can be performed by thermocompression, for example. At this time, an unbonded region (hereinafter referred to as an inlet) is provided for part (or one side) of the exterior body 509 so that an electrolyte 508 can be introduced later. As the exterior body 509, a film having an excellent barrier property against water permeation and an excellent gas barrier property is preferably used. The exterior body 509 having a stacked-layer structure including metal foil (e.g., aluminum foil) as one of intermediate layers can have a high barrier property against water permeation and a high gas barrier property.

Next, the electrolyte 508 (not illustrated) is introduced into the exterior body 509 from the inlet of the exterior body 509. The electrolyte 508 is preferably introduced in a reduced pressure atmosphere or in an inert atmosphere. Lastly, the inlet is sealed by bonding. In this manner, the laminated secondary battery 500 can be manufactured.

The electrolyte obtained in Embodiment 1 is used and the positive electrode active material 811 obtained in Embodiment 2 is used for the positive electrode 503, whereby the secondary battery 500 can have high capacity, high charge and discharge capacity, and excellent cycle performance.

This embodiment can be implemented in appropriate combination with any of the other embodiments.

### Embodiment 4

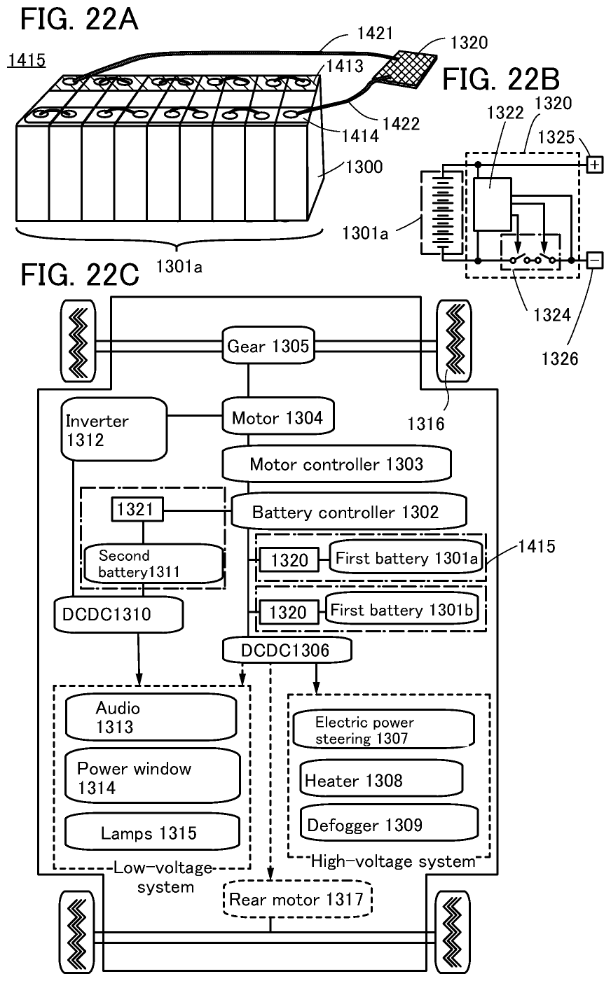

In this embodiment, an example different from the cylindrical secondary battery in FIG. 17D will be described. An example of application to an electric vehicle (EV) will be described with reference to FIG. 22C.

The electric vehicle is provided with first batteries 1301a and 1301b as main secondary batteries for driving and a second battery 1311 that supplies electric power to an inverter 1312 for starting a motor 1304. The second battery 1311 is also referred to as a cranking battery (also referred to as a starter battery). The second battery 1311 needs high output and high capacity is not so necessary, and the capacity of the second battery 1311 is lower than that of the first batteries 1301a and 1301b.

The internal structure of the first battery 1301a may be the wound structure illustrated in FIG. 18A or the stacked structure illustrated in FIG. 20A and FIG. 20B.

Although this embodiment describes an example in which two first batteries 1301a and 1301b are connected in parallel, three or more first batteries may be connected in parallel. When the first battery 1301a is capable of storing sufficient electric power, the first battery 1301b may be omitted. With a battery pack including a plurality of secondary batteries, large electric power can be extracted. The plurality of secondary batteries may be connected in parallel, connected in series, or connected in series after being connected in parallel. The plurality of secondary batteries can also be referred to as an assembled battery.

An in-vehicle secondary battery includes a service plug or a circuit breaker that can cut off high voltage without the use of equipment in order to cut off electric power from a plurality of secondary batteries. The first battery 1301a is provided with such a service plug or a circuit breaker.

Electric power from the first batteries 1301a and 1301b is mainly used to rotate the motor 1304 and is also supplied to in-vehicle parts for 42 V (such as an electric power steering 1307, a heater 1308, and a defogger 1309) through a DC-DC circuit 1306. In the case where there is a rear motor 1317 for the rear wheels, the first battery 1301a is used to rotate the rear motor 1317.

The second battery 1311 supplies electric power to in-vehicle parts for 14 V (such as an audio 1313, power windows 1314, and lamps 1315) through a DC-DC circuit 1310.

The first battery 1301a will be described with reference to FIG. 22A.

FIG. 22A shows an example in which nine rectangular secondary batteries 1300 form one battery pack 1415. The nine rectangular secondary batteries 1300 are connected in series; one electrode of each battery is fixed by a fixing portion 1413 made of an insulator, and the other electrode of each battery is fixed by a fixing portion 1414 made of an insulator. Although this embodiment shows the example in which the secondary batteries are fixed by the fixing portions 1413 and 1414, they may be stored in a battery container box (also referred to as a housing). Since a vibration or a jolt is assumed to be given to the vehicle from the outside (e.g., a road surface), the plurality of secondary batteries are preferably fixed by the fixing portions 1413 and 1414 and a battery container box, for example. Furthermore, the one electrode of each battery is electrically connected to a control circuit portion 1320 through a wiring 1421. The other electrode of each battery is electrically connected to the control circuit portion 1320 through a wiring 1422.

The control circuit portion 1320 may include a memory circuit including a transistor using an oxide semiconductor. A charge control circuit or a battery control system that includes a memory circuit including a transistor using an oxide semiconductor may be referred to as a BTOS (Battery operating system or Battery oxide semiconductor).

The control circuit portion 1320 senses a terminal voltage of the secondary battery and controls the charge and discharge state of the secondary battery. For example, to prevent overcharging, the control circuit portion 1320 can turn off an output transistor of a charging circuit and an interruption switch substantially at the same time.

FIG. 22B is an example of a block diagram of the battery pack 1415 illustrated in FIG. 22A.

The control circuit portion 1320 includes a switch portion 1324 that includes at least a switch for preventing overcharge and a switch for preventing overdischarging, a control circuit 1322 for controlling the switch portion 1324, and a portion for measuring the voltage of the first battery 1301a. The control circuit portion 1320 is set to have the upper limit voltage and the lower limit voltage of the secondary battery used, and controls the upper limit of current from the outside, the upper limit of output current to the outside, or the like. The range from the lower limit voltage to the upper limit voltage of the secondary battery is a recommended voltage range, and when a voltage is out of the range, the switch portion 1324 operates and functions as a protection circuit. The control circuit portion 1320 can also be referred to as a protection circuit because it controls the switch portion 1324 to prevent overdischarging and overcharging. For example, when the control circuit 1322 detects a voltage that is likely to cause overcharging, current is interrupted by turning off the switch in the switch portion 1324. Furthermore, a function of interrupting current in accordance with a temperature rise may be set by providing a PTC element in the charge and discharge path. The control circuit portion 1320 includes an external terminal 1325 (+IN) and an external terminal 1326 (−IN).

The switch portion 1324 can be formed by a combination of an n-channel transistor and a p-channel transistor. The switch portion 1324 is not limited to including a switch having a Si transistor using single crystal silicon; the switch portion 1324 may be formed using a power transistor containing Ge (germanium), SiGe (silicon germanium), GaAs (gallium arsenide), GaAlAs (gallium aluminum arsenide), InP (indium phosphide), SiC (silicon carbide), ZnSe (zinc selenide), GaN (gallium nitride), GaOₓ (gallium oxide; x is a real number greater than 0), or the like. A memory element using an OS transistor can be freely placed by being stacked over a circuit using a Si transistor, for example; hence, integration can be easy. Furthermore, an OS transistor can be manufactured with a manufacturing apparatus similar to that for a Si transistor and thus can be manufactured at low cost. That is, the control circuit portion 1320 using OS transistors can be stacked over the switch portion 1324 so that they can be integrated into one chip. Since the area occupied by the control circuit portion 1320 can be reduced, a reduction in size is possible.

The first batteries 1301a and 1301b mainly supply electric power to in-vehicle parts for 42 V (for a high-voltage system), and the second battery 1311 supplies electric power to in-vehicle parts for 14 V (for a low-voltage system). Lead batteries are usually used for the second battery 1311 due to cost advantage. Lead batteries have disadvantages compared with lithium-ion secondary batteries in that they have a larger amount of self-discharge and are more likely to degrade due to a phenomenon called sulfation. There is an advantage that the second battery 1311 can be maintenance-free when it uses a lithium-ion secondary battery; however, in the case of long-term use, for example three years or more, anomaly that cannot be determined at the time of manufacturing might occur. In particular, when the second battery 1311 that starts the inverter becomes inoperative, the motor cannot be started even when the first batteries 1301a and 1301b have remaining capacity; thus, in order to prevent this, in the case where the second battery 1311 is a lead storage battery, the second battery is supplied with electric power from the first battery to constantly maintain a fully-charged state.

In this embodiment, an example in which a lithium-ion secondary battery is used as each of the first battery 1301a and the second battery 1311 is described. As the second battery 1311, a lead storage battery, an all-solid-state battery, or an electric double layer capacitor may alternatively be used.

Regenerative energy generated by rolling of tires 1316 is transmitted to the motor 1304 through a gear 1305, and is stored in the second battery 1311 from a motor controller 1303 and a battery controller 1302 through a control circuit portion 1321. Alternatively, the regenerative energy is stored in the first battery 1301a from the battery controller 1302 through the control circuit portion 1320. Alternatively, the regenerative energy is stored in the first battery 1301b from the battery controller 1302 through the control circuit portion 1320. For efficient charge with regenerative energy, the first batteries 1301a and 1301b are preferably capable of fast charge.

The battery controller 1302 can set the charge voltage, charge current, and the like of the first batteries 1301a and 1301b. The battery controller 1302 can set charge conditions in accordance with charge characteristics of a secondary battery used, so that fast charge can be performed.

Although not illustrated, when the electric vehicle is connected to an external charger, a plug of the charger or a connection cable of the charger is electrically connected to the battery controller 1302. Electric power supplied from the external charger is stored in the first batteries 1301a and 1301b through the battery controller 1302. Some chargers are provided with a control circuit, in which case the function of the battery controller 1302 is not used; to prevent overcharging, the first batteries 1301a and 1301b are preferably charged through the control circuit portion 1320. In addition, a connection cable or a connection cable of the charger is sometimes provided with a control circuit. The control circuit portion 1320 is also referred to as an ECU (Electronic Control Unit). The ECU is connected to a CAN (Controller Area Network) provided in the electric vehicle. The CAN is a type of a serial communication standard used as an in-vehicle LAN. The ECU includes a microcomputer. Moreover, the ECU uses a CPU or a GPU.

Next, examples in which the secondary battery of one embodiment of the present invention is mounted on a vehicle, typically a transport vehicle, will be described.

Mounting the secondary battery illustrated in FIG. 17D or FIG. 22A on vehicles can achieve next-generation clean energy vehicles such as hybrid vehicles (HVs), electric vehicles (EVs), and plug-in hybrid vehicles (PHVs). The secondary battery can also be mounted on transport vehicles such as agricultural machines, motorized bicycles including motor-assisted bicycles, motorcycles, electric wheelchairs, electric carts, boats and ships, submarines, aircraft such as fixed-wing aircraft or rotary-wing aircraft, rockets, artificial satellites, space probes, planetary probes, or spacecraft. The secondary battery of one embodiment of the present invention can be a secondary battery with high capacity. Thus, the secondary battery of one embodiment of the present invention is suitable for reduction in size and reduction in weight and is preferably used in transport vehicles.

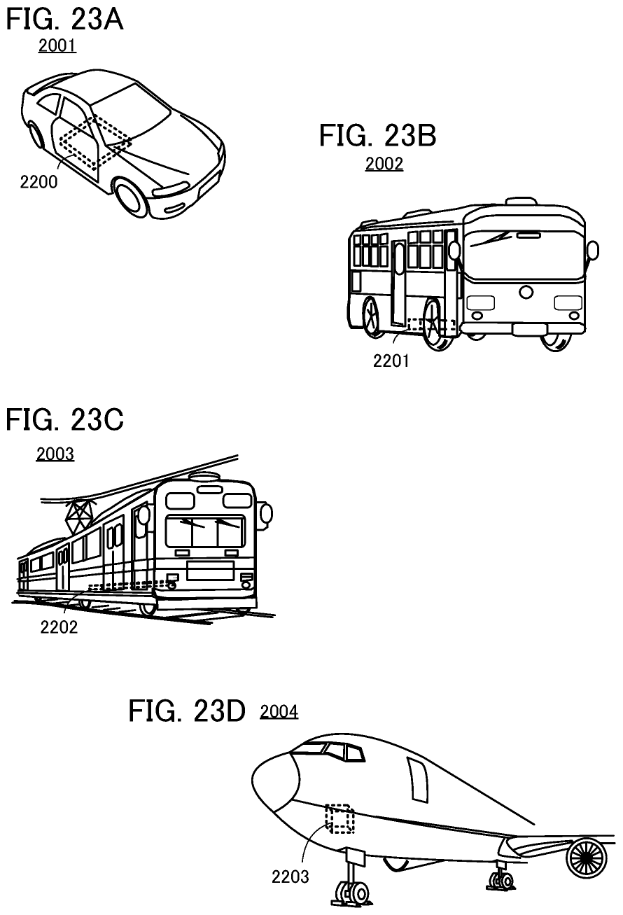

FIG. 23A to FIG. 23D show examples of transport vehicles using one embodiment of the present invention. An automobile 2001 illustrated in FIG. 23A is an electric vehicle that runs on an electric motor as a power source. Alternatively, the automobile 2001 is a hybrid electric vehicle that can appropriately select an electric motor or an engine as a driving power source. In the case where the secondary battery is mounted on the vehicle, an example of the secondary battery described in Embodiment 4 is provided at one position or several positions. The automobile 2001 illustrated in FIG. 23A includes a battery pack 2200, and the battery pack includes a secondary battery module in which a plurality of secondary batteries are connected to each other. Moreover, the battery pack preferably includes a charge control device that is electrically connected to the secondary battery module.

The automobile 2001 can be charged when the secondary battery of the automobile 2001 receives electric power from an external charge equipment through a plug-in system, a contactless charge system, and the like. In charging, a given method such as CHAdeMO (registered trademark) or Combined Charging System may be employed as a charging method, the standard of a connector, and the like as appropriate. The secondary battery may be a charging station provided in a commerce facility or a household power supply. For example, a plug-in technique enables an exterior power supply to charge a power storage device incorporated in the automobile 2001. Charging can be performed by converting AC power into DC power through a converter such as an ACDC converter.

Although not illustrated, the vehicle may include a power receiving device so that it can be charged by being supplied with electric power from an above-ground power transmitting device in a contactless manner. In the case of the contactless power feeding system, by fitting a power transmitting device in a road or an exterior wall, charging can be performed not only when the vehicle is stopped but also when driven. In addition, the contactless power feeding system may be utilized to perform transmission and reception of electric power between two vehicles. Furthermore, a solar cell may be provided in the exterior of the vehicle to charge the secondary battery when the vehicle stops or moves. To supply electric power in such a contactless manner, an electromagnetic induction method or a magnetic resonance method can be used.

FIG. 23B shows a large transporter 2002 having a motor controlled by electric power, as an example of a transport vehicle. The secondary battery module of the transporter 2002 has a cell unit of four secondary batteries with a voltage of 3.5 V or higher and 4.7 V or lower, and 48 cells are connected in series to have 170 V as the maximum voltage. A battery pack 2201 has a function similar to that in FIG. 23A except that the number of secondary batteries forming the secondary battery module of the battery pack 2201 or the like is different; thus the description is omitted.

FIG. 23C shows a large transportation vehicle 2003 having a motor controlled by electricity as an example. The secondary battery module of the transportation vehicle 2003 has more than 100 secondary batteries with 3.5 V or more and 4.7 V or lower connected in series, and the maximum voltage is 600 V, for example. Thus, the secondary batteries are required to have few variations in the characteristics. When the electrolyte described in Embodiment 1 is used and the positive electrode active material 811 obtained in Embodiment 2 is used for the positive electrode in the secondary battery, a secondary battery with stable battery characteristics can be manufactured, and mass production at low cost is possible in view of the yield. A battery pack 2202 has a function similar to that in FIG. 23A except that the number of secondary batteries forming the secondary battery module of the battery pack 2202 or the like is different; thus the detailed description is omitted.

FIG. 23D shows an aircraft 2004 having a combustion engine as an example. The aircraft 2004 shown in FIG. 23D can be regarded as a portion of a transport vehicle since it is provided with wheels for takeoff and landing, and has a battery pack 2203 including a secondary battery module and a charging control device; the secondary battery module includes a plurality of connected secondary batteries.

The secondary battery module of the aircraft 2004 has eight 4 V secondary batteries connected in series, which has the maximum voltage of 32 V, for example. A battery pack 2203 has a function similar to that in FIG. 23A except, for example, the number of secondary batteries forming the secondary battery module of the battery pack 2203; thus the detailed description is omitted.

This embodiment can be implemented in appropriate combination with any of the other embodiments.

### Embodiment 5

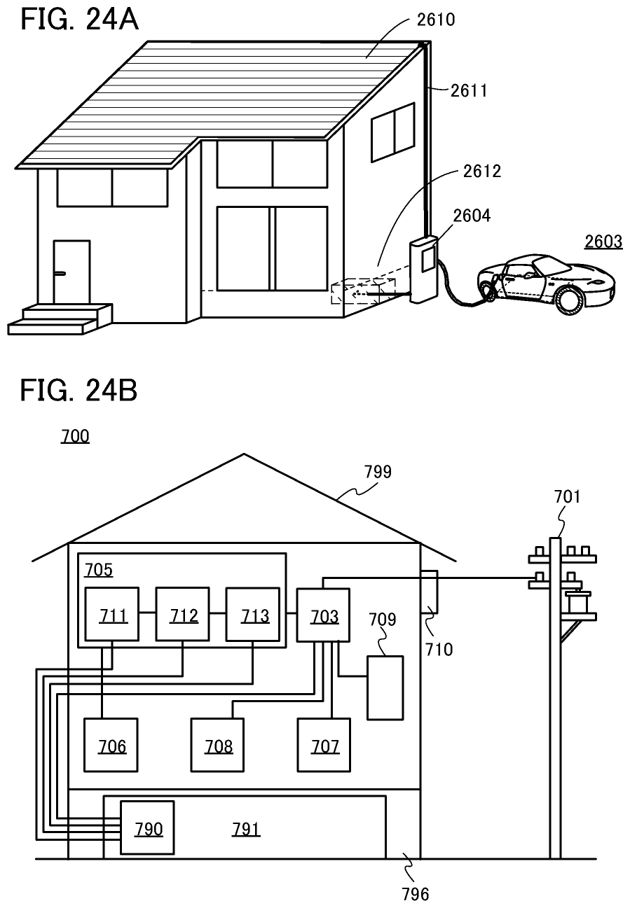

In this embodiment, examples in which the secondary battery of one embodiment of the present invention is mounted on a building are described with reference to FIG. 24A and FIG. 24B.

A house illustrated in FIG. 24A includes a power storage device 2612 including the secondary battery which is one embodiment of the present invention and a solar panel 2610. The power storage device 2612 is electrically connected to the solar panel 2610 through a wiring 2611 or the like. The power storage device 2612 may be electrically connected to ground-based charging equipment 2604. The power storage device 2612 can be charged with electric power generated by the solar panel 2610. A secondary battery included in a vehicle 2603 can be charged with the electric power stored in the power storage device 2612 through the charging equipment 2604. The power storage device 2612 is preferably provided in an underfloor space. The power storage device 2612 is provided in the underfloor space, in which case the space on the floor can be effectively used. Alternatively, the power storage device 2612 may be provided on the floor.

The electric power stored in the power storage device 2612 can also be supplied to other electronic devices in the house. Thus, with the use of the power storage device 2612 of one embodiment of the present invention as an uninterruptible power source, electronic devices can be used even when electric power cannot be supplied from a commercial power source due to power failure or the like.

FIG. 24B shows an example of a power storage device 700 of one embodiment of the present invention. As shown in FIG. 24B, a power storage device 791 of one embodiment of the present invention is provided in an underfloor space 796 of a building 799.

The power storage device 791 is provided with a control device 790, and the control device 790 is electrically connected to a distribution board 703, a power storage controller (also referred to as control device) 705, an indicator 706, and a router 709 through wirings.

Electric power is transmitted from a commercial power source 701 to the distribution board 703 through a service wire mounting portion 710. Moreover, electric power is transmitted to the distribution board 703 from the power storage device 791 and the commercial power source 701, and the distribution board 703 supplies the transmitted electric power to a general load 707 and a power storage load 708 through outlets (not shown).

The general load 707 is, for example, an electronic device such as a TV or a personal computer. The power storage load 708 is, for example, an electronic device such as a microwave, a refrigerator, or an air conditioner.

The power storage controller 705 includes a measuring portion 711, a predicting portion 712, and a planning portion 713. The measuring portion 711 has a function of measuring the amount of electric power consumed by the general load 707 and the power storage load 708 during a day (e.g., from midnight to midnight). The measuring portion 711 may have a function of measuring the amount of electric power of the power storage device 791 and the amount of electric power supplied from the commercial power source 701. The predicting portion 712 has a function of predicting, on the basis of the amount of electric power consumed by the general load 707 and the power storage load 708 during a given day, the demand for electric power consumed by the general load 707 and the power storage load 708 during the next day. The planning portion 713 has a function of making a charge and discharge plan of the power storage device 791 on the basis of the demand for electric power predicted by the predicting portion 712.

The amount of electric power consumed by the general load 707 and the power storage load 708 and measured by the measuring portion 711 can be checked with the indicator 706. It can be checked with an electronic device such as a TV or a personal computer through the router 709. Furthermore, it can be checked with a portable electronic terminal such as a smartphone or a tablet through the router 709. With the indicator 706, the electronic device, or the portable electronic terminal, for example, the demand for electric power depending on a time period (or per hour) that is predicted by the predicting portion 712 can be checked.

This embodiment can be implemented in appropriate combination with any of the other embodiments.

### Embodiment 6

In this embodiment, examples of electronic devices each including the secondary battery of one embodiment of the present invention are described. Examples of the electronic device including the secondary battery include a television device (also referred to as a television or a television receiver), a monitor of a computer and the like, a digital camera, a digital video camera, a digital photo frame, a mobile phone (also referred to as a cellular phone or a mobile phone device), a portable game console, a portable information terminal, an audio reproducing device, and a large-sized game machine such as a pachinko machine. Examples of the portable information terminal include a laptop personal computer, a tablet terminal, an e-book reader, and a mobile phone.

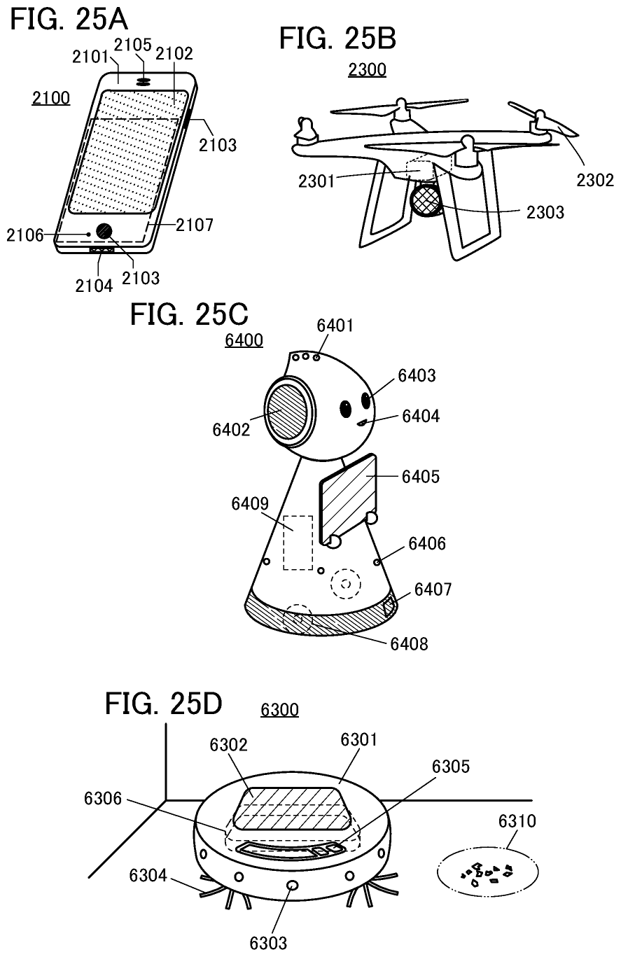

FIG. 25A shows an example of a mobile phone. A mobile phone 2100 includes a housing 2101 in which a display portion 2102 is incorporated, an operation button 2103, an external connection port 2104, a speaker 2105, a microphone 2106, and the like. The mobile phone 2100 includes a secondary battery 2107. With the use of the secondary battery 2107 in which the electrolyte in Embodiment 1 is used and the positive electrode active material 811 in Embodiment 2 is used for the positive electrode, high capacity and a structure that accommodates space saving due to a reduction in size of the housing can be achieved.

The mobile phone 2100 is capable of executing a variety of applications such as mobile phone calls, e-mailing, viewing and editing texts, music reproduction, Internet communication, and a computer game.

With the operation button 2103, a variety of functions such as time setting, power on/off, on/off of wireless communication, setting and cancellation of a silent mode, and setting and cancellation of a power saving mode can be performed. For example, the functions of the operation button 2103 can be set freely by the operating system incorporated in the mobile phone 2100.

In addition, the mobile phone 2100 can execute near field communication conformable to a communication standard. For example, mutual communication between the mobile phone 2100 and a headset capable of wireless communication can be performed, and thus hands-free calling is possible.

Moreover, the mobile phone 2100 includes the external connection port 2104, and data can be directly transmitted to and received from another information terminal via a connector. In addition, charge can be performed via the external connection port 2104. Note that the charging operation may be performed by wireless power feeding without using the external connection port 2104.

The mobile phone 2100 preferably includes a sensor. As the sensor, a human body sensor such as a fingerprint sensor, a pulse sensor, or a temperature sensor, a touch sensor, a pressure sensitive sensor, or an acceleration sensor is preferably mounted, for example.

FIG. 25B shows an unmanned aircraft 2300 including a plurality of rotors 2302. The unmanned aircraft 2300 is also referred to as a drone. The unmanned aircraft 2300 includes a secondary battery 2301 of one embodiment of the present invention, a camera 2303, and an antenna (not illustrated). The unmanned aircraft 2300 can be remotely controlled through the antenna. A secondary battery employing the electrolyte described in Embodiment 1 and the positive electrode active material 811 obtained in Embodiment 2 for the positive electrode has a high energy density and a high degree of safety, and thus can be used safely for a long time over a long period of time and is suitable for the secondary battery included in the unmanned aircraft 2300.

FIG. 25C shows an example of a robot. A robot 6400 shown in FIG. 25C includes a secondary battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like.

The microphone 6402 has a function of detecting a speaking voice of a user, an environmental sound, and the like. The speaker 6404 has a function of outputting sound. The robot 6400 can communicate with the user using the microphone 6402 and the speaker 6404.

The display portion 6405 has a function of displaying various kinds of information. The robot 6400 can display information desired by the user on the display portion 6405. The display portion 6405 may be provided with a touch panel. Moreover, the display portion 6405 may be a detachable information terminal, in which case charge and data communication can be performed when the display portion 6405 is set at the home position of the robot 6400.

The upper camera 6403 and the lower camera 6406 each have a function of taking an image of the surroundings of the robot 6400. The obstacle sensor 6407 can detect an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 further includes, in its inner region, the secondary battery 6409 of one embodiment of the present invention and a semiconductor device or an electronic component. A secondary battery employing the electrolyte described in Embodiment 1 and the positive electrode active material 811 obtained in Embodiment 2 for the positive electrode has high energy density and a high degree of safety, and thus can be used safely for a long time over a long period of time and is suitable as the secondary battery 6409 included in the robot 6400.

FIG. 25D shows an example of a cleaning robot. A cleaning robot 6300 includes a display portion 6302 placed on the top surface of a housing 6301, a plurality of cameras 6303 placed on the side surface of the housing 6301, a brush 6304, operation buttons 6305, a secondary battery 6306, a variety of sensors, and the like. Although not illustrated, the cleaning robot 6300 is provided with a tire, an inlet, and the like. The cleaning robot 6300 is self-propelled, detects dust 6310, and sucks up the dust through the inlet provided on the bottom surface.

For example, the cleaning robot 6300 can determine whether there is an obstacle such as a wall, furniture, or a step by analyzing images taken by the cameras 6303. In the case where the cleaning robot 6300 detects an object, such as a wire, that is likely to be caught in the brush 6304 by image analysis, the rotation of the brush 6304 can be stopped. The cleaning robot 6300 includes, in its inner region, the secondary battery 6306 of one embodiment of the present invention and a semiconductor device or an electronic component. A secondary battery employing the electrolyte described in Embodiment 1 and the positive electrode active material 811 obtained in Embodiment 2 for the positive electrode has high energy density and a high degree of safety, and thus can be used safely for a long time over a long period of time and is suitable for the secondary battery 6306 included in the cleaning robot 6300.

This embodiment can be implemented in appropriate combination with the other embodiments.

### Example 1

In this example, coin-type battery cells were fabricated, and each of them was subjected to a 1C cycle test at 85° C., a 1C cycle test at 60° C., a 1C cycle test at 0° C., and a 0.05C charge and discharge test at −40° C.

Samples 1, 2, 3, and 4 fabricated in this example are described.

A nickel-cobalt-manganese oxide (NCM523 produced by MTI) in which the ratio of nickel to cobalt to manganese is Ni:Co:Mn=5:2:3 was used as a positive electrode active material of each sample.

Using the formed positive electrodes, CR2032 type coin battery cells (a diameter of 20 mm, a height of 3.2 mm) were fabricated.

A lithium metal was used for a counter electrode.

For an electrolyte of Sample 1, 1 mol/L of lithium hexafluorophosphate (LiPF₆) was used, and a mixture of monofluoroethylene carbonate (FEC) and diethyl carbonate (DEC) at FEC:DEC=3:7 (volume ratio) was used. Note that lithium hexafluorophosphate (LiPF₆) is also called a supporting salt (supporting electrolyte), which increases the conductivity of a liquid electrolyte.

For an electrolyte of Sample 2 as a comparative example, 1 mol/L of lithium hexafluorophosphate (LiPF₆) was used, and ethylene carbonate (EC) and diethyl carbonate (DEC) were mixed at EC:DEC=3:7 (volume ratio).

For an electrolyte of Sample 3 as a comparative example, 1 mol/L of lithium hexafluorophosphate (LiPF₆) was used, and ethylene carbonate (EC), ethyl methyl carbonate (EMC), and dimethyl carbonate (DMC) were mixed at EC:EMC:DMC=3:3.5:3.5 (volume ratio).

For an electrolyte of Sample 4, 1 mol/L of lithium hexafluorophosphate (LiPF₆) was used, and monofluoroethylene carbonate (FEC), ethyl methyl carbonate (EMC), and dimethyl carbonate (DMC) were mixed at FEC:EMC:DMC=3:3.5:3.5 (volume ratio).

As a separator, 25-μm-thick polypropylene was used.

A positive electrode can and a negative electrode can that were formed using stainless steel (SUS) were used.

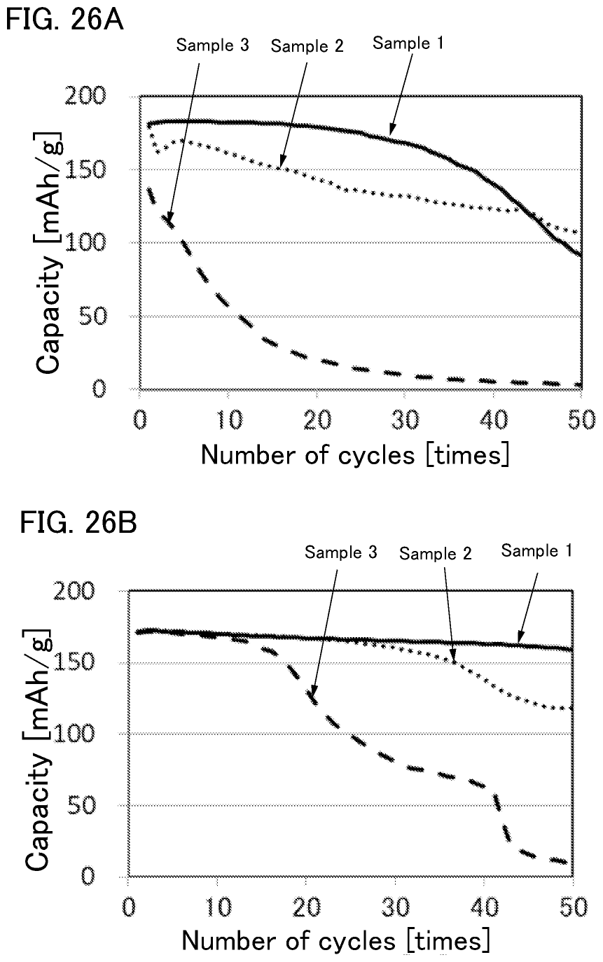

FIG. 26A shows the results of the 1C cycle tests at 85° C. performed on Sample 1, Sample 2, and Sample 3. For the cycle tests, CCCV charge (1 C, 4.3 V, and a termination current of 0.1 C) and CC discharge (1 C and 2.5 V) were performed.

FIG. 26B shows the results of the 1C cycle tests at 60° C. performed on Sample 1, Sample 2, and Sample 3.

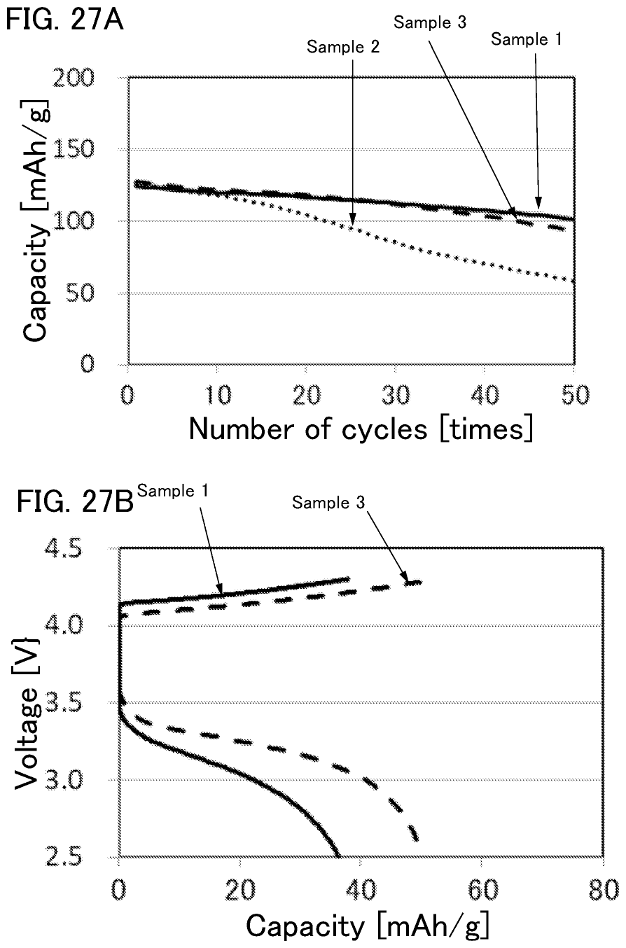

FIG. 27A shows the results of the 1C cycle tests at 0° C. performed on Sample 1, Sample 2, and Sample 3.

FIG. 27B shows the results of the 0.05C charge and discharge tests at −40° C. performed on Sample 1 and Sample 3. Note that 0.05C charge and discharge at −40° C. could not be performed on Sample 2.

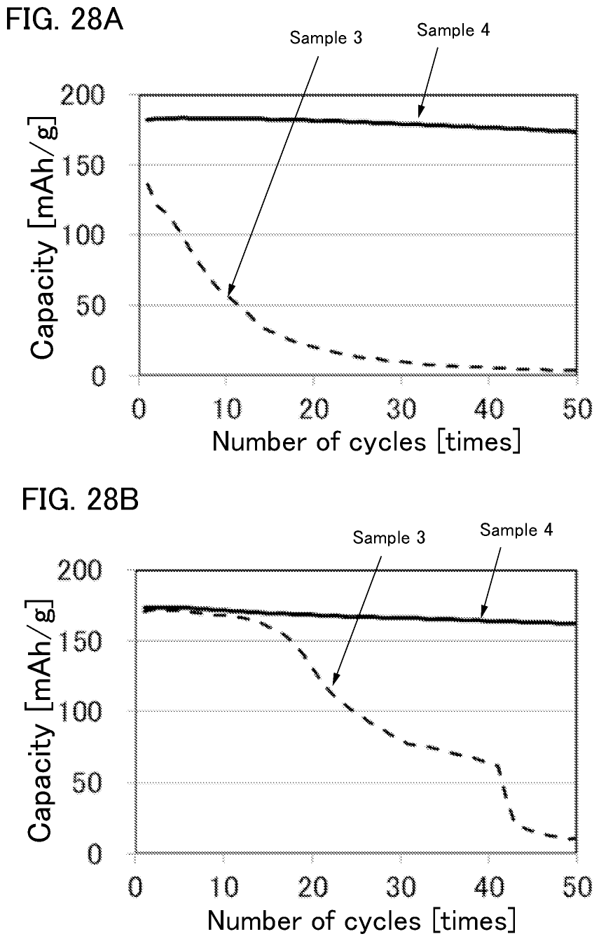

FIG. 28A shows the results of the 1C cycle tests at 85° C. performed on Sample 4 and Sample 3.

FIG. 28B shows the results of the 1C cycle tests at 60° C. performed on Sample 4 and Sample 3.

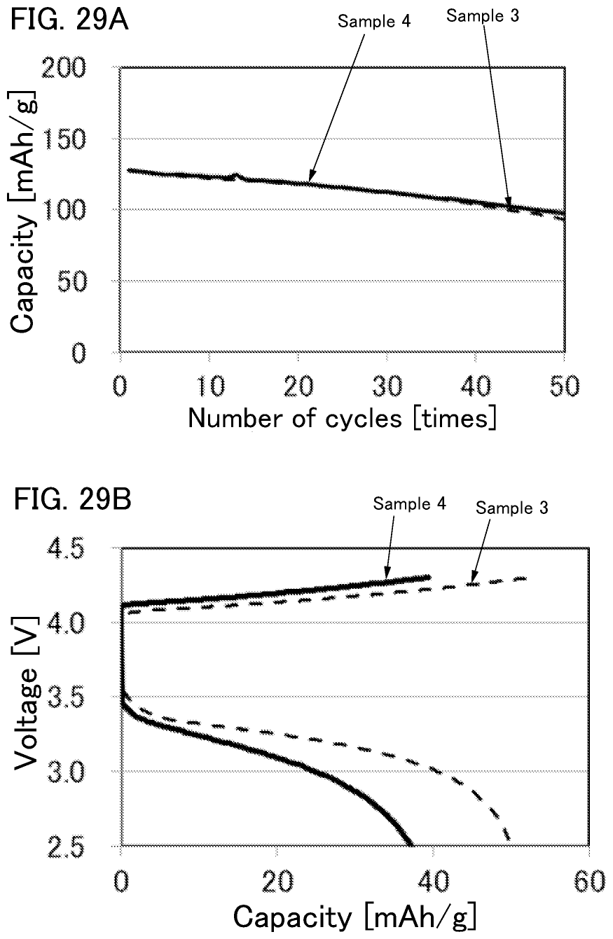

FIG. 29A shows the results of the 1C cycle tests at 0° C. performed on Sample 4 and Sample 3.

FIG. 29B shows the results of the 0.05C charge and discharge tests at −40° C. performed on Sample 4 and Sample 3.

It is found from these results that when compounds containing fluorine are used as the electrolytes of Sample 1 and Sample 4, 0.05C charge and discharge are possible at −40° C. and the cycle performance is favorable at 85° C. In the case of the electrolytes as the comparative examples, 0.05C charge and discharge are impossible at −40° C., or the cycle performance is significantly degraded at 85° C.

The above results verified that the use of the electrolyte of one embodiment of the present invention enabled use at a wide range of temperatures, specifically, at temperatures higher than or equal to −40° C. and lower than or equal to 85° C. Thus, even when the temperature outside a vehicle equipped with a secondary battery of one embodiment of the present invention is higher than or equal to −40° C. and lower than 25° C. or higher than or equal to 25° C. and lower than or equal to 85° C., the vehicle can be driven with use of the secondary battery as a power source.

### REFERENCE NUMERALS

10: positive electrode current collector, 11: negative electrode current collector, 300: secondary battery, 301: positive electrode can, 302: negative electrode can, 303: gasket, 304: positive electrode, 305: positive electrode current collector, 306: positive electrode active material layer, 307: negative electrode, 308: negative electrode current collector, 309: negative electrode active material layer, 310: separator, 500: secondary battery, 501: positive electrode current collector, 502: positive electrode active material layer, 503: positive electrode, 504: negative electrode current collector, 505: negative electrode active material layer, 506: negative electrode, 507: separator, 508: electrolyte, 509: exterior body, 510: positive electrode lead electrode, 511: negative electrode lead electrode, 550: current collector, 551: active material, 553: acetylene black, 554: graphene, 555: carbon nanotube, 556: electrolyte, 561: active material, 562: active material, 600: secondary battery, 601: positive electrode cap, 602: battery can, 603: positive electrode terminal, 604: positive electrode, 605: separator, 606: negative electrode, 607: negative electrode terminal, 608: insulating plate, 609: insulating plate, 611: PTC element, 613: safety valve mechanism, 614: conductive plate, 615: power storage system, 616: secondary battery, 620: control circuit, 621: wiring, 622: wiring, 623: wiring, 624: conductor, 625: insulator, 626: wiring, 627: wiring, 628: conductive plate, 700: power storage device, 701: commercial power source, 703: distribution board, 705: power storage controller, 706: indicator, 707: general load, 708: power storage load, 709: router, 710: service wire mounting portion, 711: measuring portion, 712: predicting portion, 713: planning portion, 790: control device, 791: power storage device, 796: underfloor space, 799: building, 801: composite oxide, 802: fluoride, 803: compound, 804: mixture, 806: metal Z-containing material, 807: lithium compound, 808: cobalt-containing material, 810: mixture, 811: positive electrode active material, 911a: terminal, 911b: terminal, 913: secondary battery, 930: housing, 930a: housing, 930b: housing, 931: negative electrode, 931a: negative electrode active material layer, 932: positive electrode, 932a: positive electrode active material layer, 933: separator, 950: wound body, 950a: wound body, 951: terminal, 952: terminal, 1300: rectangular secondary battery, 1301a: battery, 1301b: battery, 1302: battery controller, 1303: motor controller, 1304: motor, 1305: gear, 1306: DC-DC circuit, 1307: electric power steering, 1308: heater, 1309: defogger, 1310: DC-DC circuit, 1311: battery, 1312: inverter, 1313: audio, 1314: power window, 1315: lamps, 1316: tire, 1317: rear motor, 1320: control circuit portion, 1321: control circuit portion, 1322: control circuit, 1324: switch portion, 1325: external terminal, 1326: external terminal, 1413: fixing portion, 1414: fixing portion, 1415: battery pack, 1421: wiring, 1422: wiring, 2001: automobile, 2002: transporter, 2003: transportation vehicle, 2004: aircraft, 2100: mobile phone, 2101: housing, 2102: display portion, 2103: operation button, 2104: external connection port, 2105: speaker, 2106: microphone, 2107: secondary battery, 2200: battery pack, 2201: battery pack, 2202: battery pack, 2203: battery pack, 2300: unmanned aircraft, 2301: secondary battery, 2302: rotor, 2303: camera, 2603: vehicle, 2604: charging equipment, 2610: solar panel, 2611: wiring, 2612: power storage device, 6300: cleaning robot, 6301: housing, 6302: display portion, 6303: camera, 6304: brush, 6305: operation button, 6306: secondary battery, 6310: dust, 6400: robot, 6401: illuminance sensor, 6402: microphone, 6403: upper camera, 6404: speaker, 6405: display portion, 6406: lower camera, 6407: obstacle sensor, 6408: moving mechanism, 6409: secondary battery

1. A secondary battery comprising:
a positive electrode;
an electrolyte; and
a negative electrode,
wherein the electrolyte comprises:
an acyclic ester; and
a fluorinated carbonic ester at 5 vol. % or higher and 95 vol. % or lower.

2. The secondary battery according to claim 1, wherein the fluorinated carbonic ester is fluorinated ethylene carbonate.

3. The secondary battery according to claim 1, wherein the acyclic ester is diethyl carbonate.

4. The secondary battery according to claim 1, wherein the electrolyte comprises a lithium ion solvated by the fluorinated carbonic ester.

5. A secondary battery comprising:
a positive electrode;
an electrolyte; and
a negative electrode,
wherein the electrolyte comprises:
an acyclic ester; and
cyclic carbonate with an electron-withdrawing group at 5 vol. % or higher and 95 vol. % or lower.

6. The secondary battery according to claim 5, wherein the electron-withdrawing group is a fluoro group or a cyano group.

7. The secondary battery according to claim 1, wherein the proportion of the acyclic ester is 5 vol. % or higher and 80 vol. % or lower in the electrolyte.

8. The secondary battery according to claim 1, wherein the acyclic ester comprises fluorine.

9. The secondary battery according to claim 1, wherein the positive electrode comprises graphene or carbon nanotube.

10. The secondary battery according to claim 1,
wherein the positive electrode comprises a positive electrode active material, and
wherein a magnesium concentration of a surface portion of the positive electrode active material is higher than a magnesium concentration of the inside of the positive electrode active material.

11. The secondary battery according to claim 1,
wherein the positive electrode active material comprises a positive electrode active material, and
wherein the positive electrode active material comprises fluorine.

12. A vehicle comprising the secondary battery according to claim 1.
